(19) United States
(12) Patent Application Publication
(10) Pub. No.: US 2007/0076625 A1
(43) Pub. Date: Apr. 5, 2007

(54) DATA COMMUNICATION APPARATUS

(75) Inventors: Hitoshi TAHARA, Osaka (JP); Yohei KANEKO, Osaka (JP); Yoshiyuki HAYASHI, Osaka (JP); Aki HIRAKI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/535,190

(22) Filed: Sep. 26, 2006

(30) Foreign Application Priority Data
Sep. 30, 2005 (JP) 2005/289089

(51) Int. Cl. H04J 1/16; H04L 12/56; H04L 12/54

(52) U.S. Cl. 370/252; 370/428; 370/412; 370/394

(57) ABSTRACT

An object of the present invention is to provide a data communication apparatus for performing communication of an IP packet in accordance with a plurality of communication protocols, which can reduce generation of an unnecessary configuration and unnecessary processing. The data communication apparatus according to the present invention includes a head packet determining unit 302 to store the destination information owned by a head packet in a control information storing unit 307, a passing destination determining unit 305 to determine an output destination of the head packet on the basis of the destination information, and a following packet determining unit 303 to pass a following packet to the passing destination determining unit 305 when the destination information is stored in the control information storing unit 307 and store the following packet in a buffer 309 when the destination information is not stored in the control information storing unit 307, and the passing destination determining unit 305 determines the output destination of the following packet on the basis of the destination information stored in a destination information storing unit.

### BACKGROUND OF THE INVENTION

(1) Field of the Invention

The present invention relates to a data communication apparatus for performing data communication with an other device via a network in accordance with a predetermined communication protocol.

(2) Description of the Related Art

In recent years, setting up or a home network in accordance with Digital Living Network Alliance (DLNA) has been actively carried out, and AV networking equipment corresponding to DLNA has been produced on a commercial basis.

The DLNA is a standard aiming that a general consumer realizes a seamless interconnection environment for products manufactured by different manufacturers, which is connected through a home networking, so as to enable the consumer to access and enjoy contents, of which high compatibility is assured from any referenced product.

In the DLNA, a design guideline is defined about a media server, which is important for interconnection between the devices in a home network environment and the device to reproduce the contents in this network.

In these days, the Audio and Visual (AV) data transmission has been performed at home, and it is necessary to transmit the AV data of a high transmission rate because of the start of a digital terrestrial broadcasting and the like.

In this background, in the AV device using a Central Processing Unit (CPU) having a low capacity for reduction of a cost, it is general that two CPUs are used, namely, a CPU for high-speed transmission in order to perform the AV data transmission at a high transmission rate and a CPU to perform other data communication (refer to JP-A-2000-235536 (PP.4 to 5, FIG. 1), for example).

Further, a communication protocol for performing the data communication is installed in the both CPUs. One communication protocol to be installed is configured by hardware (refer to JP-A-2002-354046 (P.4, FIG. 2), for example) and software. In addition, the both CPUs are connected through a bus so as to perform the communication between the CPUs.

Here, as the communication protocol, a Transmission Control Protocol/Internet Protocol (TCP/IP) is used as a standard. A TCP/IP is a communication protocol, which is a standard on Internet and has been the most widely used in the world. It is assumed that the TCP/IP generally includes a User Datagram Protocol (UDP), an Internet Control Message Protocol (ICMP), and an Address Resolution Protocol (ARP) as well as the TCP and the IP. The ICMP and the ARP will be described later.

A conventional method to transmit the AV data at a high transmission rate by two CPUs in a conventional AV networking equipment will be described with reference to FIG. 1.

FIG. 1 is a functional block diagram showing functional structures of a conventional AV data transmitter and AV data receiver.

The AV data transmission system shown in FIG. 1 is configured by an AV data transmitter 10 having the AV contents compressed by a Moving Picture Experts Group (MPEG) standard or the like recorded in a recording device and an AV data receiver 13 to reproduce the AV data transmitted from the AV data transmitter using a reproducing device. The AV data receiver 13 uses the TCP/IP as a communication protocol to be connected to the AV data transmitter via a network.

The illustration and explanation of the above-described recording device, a reproducing device and the like are omitted and only constituent elements related to transmission of the AV data will be illustrated and explained.

The AV data transmitter 10 is provided with an apparatus for high-speed transmission 12 to transmit the AV data and a host apparatus 11 for making the data communication other than transmission of the AV data. The AV data receiver 13 is provided with the apparatus for high-speed transmission 12 and a host apparatus 14 in a similar way.

Each of the host apparatus 11 and the host apparatus 14 includes a first communication protocol unit 102 for performing communication in accordance with a first communication protocol and a first interface (I/F) unit 10t for accessing the first communication protocol unit 102. In addition, each of the host apparatus 11 and the host apparatus 14 includes: a communication application program (hereinafter, also referred to as “APP”) using the first communication protocol unit 102 via the first interface (I/F) unit 101; an AV transmission application program using a second communication protocol unit 122 provided to the apparatus for high-speed transmission 12; and an information setting unit 103 for setting the information provided to the host apparatus in advance in the apparatus for high-speed transmission 12.

The apparatus for high-speed transmission 12 has the second communication protocol unit 122, used by the AV data transmission application program, for making the communication by the second communication protocol; a second I/F unit 121 for accessing the second communication protocol unit 122; a transmission and reception unit 123 for transmitting the data inputted from the first communication protocol unit 102 or the second communication protocol unit 122 to an other device and outputting the received data to a packet sorting unit 124 via a network; and the packet sorting unit 124 for outputting the received data inputted from the transmission and reception unit 123 to be sorted to the first communication protocol unit 102 or the second communication protocol unit 122.

The communication application program owned by the host apparatus 11 and the host apparatus 14, specifically, a server APP 105, a client APP 106, a client APP 108, and a server APP 109 are an application program to directly supply a service or use the service and an application program to control the AV data transmitter 10, the AV data receiver 13, or the like.

One of application programs to directly supply a service uses a communication protocol such as a File Transfer Protocol (FTP), a Hyper Text Transfer Protocol (HTTP), and a Simple Mail Transfer Protocol (SMTP) or the like, which are located, for example, at an upper protocol of the TCP/IP. In addition, there is a proprietary application program provided as this application program.

Many communication application programs using the TCP/IP are manufactured according to a client/server model. The communication application programs of the host apparatus 11 and the host apparatus 14 conform to this.

In addition, an AV transmission server APP 104 owned by the 20 AV data transmitter 10 is a server application, and an AV transmission client APP 107 owned by the AV data transmitter 13 is a client application.

The communication application program using the TCP/IP opens a communication line between the application programs by using a port number. The port number is used when the TCP and the UDP identify the application program.

The first I/F unit 101 and the second I/F unit 121 are Application Programming Interfaces (API) generally called as sockets.

The information setting unit 103 of the host apparatus 11 sets the information such as an IP address and a subnet mask used in the host apparatus 11 in the apparatus for high-speed transmission 12 by using a communication path A. The first communication protocol unit 102 inputs the data to be transmitted to the transmission and reception unit 123 by using a communication path B. The AV transmission server APP 104 communicates with the second communication protocol unit 122 via the second I/F unit 121 by using a communication path C. The second communication protocol unit 122 inputs the data to be transmitted to the transmission and reception unit 123 by using a communication path D. The packet sorting unit 124 outputs the data received by using the communication path B and the communication path D to be sorted to the first communication protocol unit 102 and the second communication protocol unit 122. Further, each constituent element of the host apparatus 14 of the AV data receiver 13 performs the same operation.

Specifically, the above-described packet sorting unit 124 will sort the data according to a method, which will be described next.

Upon connection, the AV transmission client APP 107 of the AV data receiver 13 inputs a connection destination port number and a port number used in the second communication protocol unit 122 to the second communication protocol unit 122 via the communication path C and the second I/F unit 121. Thereby, the AV transmission client APP 107 establishes a communication line with the AV transmission server APP 104 of the AV data transmitter 10. Then, the AV transmission client APP 107 receives the AV data by using this established port number.

The AV transmission server APP 104 of the AV data transmitter 10 inputs a port number to be used to the second communication protocol unit 122 via the communication path C and the second I/F unit 121 to open the communication line to be used, and the AV transmission server APP 104 stands ready. When the communication line is established by the AV transmission client APP 107, the AV transmission server APP 104 transmits the AV data.

Each of the above-described port numbers used by the AV transmission client APP 107 and the AV transmission server APP 104 is set in each packet sorting unit 124 via the communication path D as one for transmitting the AV data.

Checking this set port number against the port number of the received packet, if it is the appropriate packet, the packet sorting unit 124 outputs it to the second communication protocol unit 122 by the communication path D. If it is not the appropriate packet, the packet sorting unit 124 outputs it to the first communication protocol unit 102 by the communication path B.

The AV data transmitter 10 and the AV data receiver 13 transmit the AV data of the high-transmission rate by the above-described structure and operation.

The conventional art related to the present invention of the present structure will be described from (1) to (4).

(1) It is general that an Internet Protocol (IP) has a function to divide a packet (fragment) in accordance with the maximum transmission unit (the Maximum Transmission Unit (MTU) size) allowed by a network through which the data passes.

In other words, if the packet given from the application program is larger than the MTU size, the transmission side transmits the packet while dividing it. The reception side reconstructs the received divided packet (the fragment packet) into the original packet.

Here, the fragment in the IP is referred to as an IP fragment and each divided packet generated from the IP fragment is referred to as an IP fragment packet.

FIG.2A is a diagram showing an example of a flow of the processing from generation of an IP fragment until reconstruction of an IP fragment packet. FIG. 2B is a diagram showing an example of an IP fragment packet.

A MTU size at the network, on which a device A at the transmission side and a device B at the reception side are connected, is 1,500 octets. Here, as shown in FIG. 2A, it is assumed that a network, of which MTU size is 620 octets, is located on this network. In such a network structure, in the case that the device A transmits the data of 1,000 octets to the device B, the IP packet is divided into a packet of 600 octets and a packet of 400 octets by a router a located at a boundary of the network to be transmitted. Then, as shown in FIG. 2B, the information of a TCP header (or a UDP header) is only located at the divided head packet. In other words, the port number to specify the communication protocol unit as a destination of the IP packet is only located at the head packet but this port number is not located at the following packet.

In addition, the IP fragment packet may reach in no particular order depending on the circumstance of the network. At the worst, the packet may be lost on the network. In the IP, as a function of reconstruction the IP fragment packet, a packet reaching in no particular order is also allowed.

FIG. 3 is a diagram showing the outline of the processing when the IP fragment packet cannot be reconstructed.

As shown in FIG. 3, in the case that a part of the IP fragment packet is lost on the network and the IP fragment packet cannot be reconstructed, the IP discards the packet, which could not be reconstructed because a timer value elapsing from 60 sec to 120 sec described as a recommended timer value in the RFC 1122. Upon discard, only in the case of receiving the head packet, the IP transmits an ICMP time out message (an ICMP fragment error message) by an Internet Control Protocol (ICMP) to a transmission source so as to notify that the IP fragment packet cannot be reconstructed. The above-described RFC is the abbreviation of so Request For Comments and this is a document normally issued by an IETF, which is an association to determine a standard of the art related to Internet.

A fragment reconstruction unit 210 of the conventional packet sorting unit 124 checks the port number included in the head packet and outputs it to the communication protocol unit corresponding to the transmission destination after completion of reconstruction of the IP fragment packet. In other words, in accordance with the port number, the fragment reconstruction unit 210 outputs a packet reconstructed to the first communication protocol unit 102 or the second communication protocol unit 122.

In addition, the remaining packet, which could not be reconstructed, is discarded due to elapse of 120 sec (a recommended maximum value of the timer value). Then, upon discard, if the fragment reconstruction unit 210 receives the head packet, the fragment reconstruction unit 210 transmits the ICMP time out message (an ICMP fragment error message). Thus, in the case of receiving the IP fragment packet, the processing performed by the IP, namely, the processing performed by the first communication protocol unit 102 and the second communication protocol unit 122 is also carried out by the packet sorting unit 124.

FIG. 4 is a functional block showing a functional structure of a conventional fragment reconstruction unit. A packet sorting unit 124a in the drawing is a functional block representing a function in the packet sorting unit 124 other than the function of the fragment reconstruction unit 210.

With reference to FIG. 4, the structure of a conventional fragment reconstruction unit will be described.

The received packet is inputted to a fragment determining unit 401, and the fragment determining unit 401 determines whether the received packet is the IP fragment packet or not. Then, if this packet is that other than the IP fragment packet, the fragment determining unit 401 passes the packet to a packet sorting unit 124a and if this packet is the IP fragment packet, the fragment determining unit 401 outputs the packet to a head packet and following packet determining unit 402.

The head packet and following packet determining unit 402 stores the IP fragment packet to be inputted in a buffer 407 and updates the information of the reconstruction information stored in a reconstruction information storing unit 406. Further, the head packet and following packet determining unit 402 notifies fragment completion determining unit 403 that it has received the packet. Then, when the head packet and following packet determining unit 402 receives an IP fragment packet, which is a fragment of a new IP packet, the head packet and following packet determining unit 402 starts a timer for discarding this IP fragment packet after 120 sec.

FIG. 5A is a view showing an IP header format, FIG. 5B is a view showing a correspondence between a value of a PROTOCOL area included in the IP header and a protocol name, and FIG. 5C is a view showing a correspondence between a bit of a FLAGS area included in the IP header and a meaning thereof.

Depending on four kinds of information, namely, ID3405, FLAGS3406, OFFSET3407, and TOTAL_LEN3404 included in the IP header shown in FIG. 5A, the IP fragment packet is identified. The information made of these four kinds of information is referred to as “an IP fragment identification information”. On the basis of the IP fragment identification information, the reconstruction information is updated and the timer is started.

Receiving a notification of reach of the IP fragment packet, a fragment completion determining unit 403 determines completion of reconstruction from the reconstruction information. When the reconstruction is completed, the fragment completion determining unit 403 notifies a passing destination determining unit 404. Receiving the notification, the passing destination determining unit 404 reads the all IP fragment packets, which have been completely reconstructed and stored in a buffer 407, erases the information of a reconstruction information storing unit 406, and stops the timer. Then, checking a port number included in a TCP header (or a UDP header) provided to the IP fragment packet at the head and deciding the communication path, the fragment completion determining unit 403 requests output of the IP fragment packet, which has been completely reconstructed, of a passing unit 405.

According to request, the passing unit 405 outputs the completely reconstructed IP fragment packet to the communication path B or the communication path D.

If time-out of the timer occurs without completion of reconstruction, an information erasing unit 408 erases the reconstruction information relating to the IP fragment packet to time out from the reconstruction information storing unit 406 and discards the IP fragment packet in the buffer 407, which could not be reconstructed. In this case, the information erasing unit 408 also determines whether the head packet is received from the reconstruction information or not. Only when the head packet has been received, using the information included in the head packet, the information erasing unit 408 generates an ICMP time out message (an ICMP fragment error message) The generated ICMP fragment error message is transmitted to a transmission source of this IP fragment packet by the transmission and reception unit 123.

The conventional fragment reconstruction unit 210 is configured and is operated as described above.

(2) It is general that the communication protocol (TCP/IP) includes an ICMP for supplementing the IP. When the IP packet could not reach due to a failure, the failure is notified by the ICMP

The ICMP error message has some types to be defined by the RFC792, and this ICMP error message is transmitted using the IP. Accordingly, since the ICMP error message is the packet without the TCP header (or the UDP header), the packet sorting unit cannot determine to which communication protocol unit the packet sorting unit outputs the ICMP error message.

Therefore, an ICMP replicating unit 211 of the conventional packet sorting unit 124 replicates the received ICMP error message packet, and outputs this to the first communication protocol unit 102 and the second communication protocol unit 122.

FIG. 6 is a functional block diagram showing a functional structure of a conventional ICMP replicating unit. A packet sorting unit 124a in the drawing is a functional block representing a function in the packet sorting unit 124 other than the function of the ICMP replicating unit 211. With reference to FIG. 6, the structure and the operation of the ICMP replicating unit will be described below.

The received packet is inputted to an ICMP packet determining unit 701, and the ICMP packet determining unit 701 determines whether the inputted packet is the ICMP packet or not. If the inputted packet is the packet other than the ICMP packet, the ICMP packet determining unit 701 passes it to the packet sorting unit 124a, and if the inputted packet is the ICMP packet, the ICMP packet determining unit 701 outputs it to a packet replicating unit 702. The packet replicating unit 702 replicates the inputted ICMP packet, and outputs two ICMP packets to a passing unit 703 together with a request to transmit the ICMP packet to the communication path B and the communication path D. The passing unit 703 outputs the ICMP packet to the communication path B and the communication path D, respectively, in accordance with the request.

Briefly, the ICMP packet will be outputted to both of the first communication protocol unit 102 and the second communication protocol unit 122.

The conventional ICMP replicating unit 211 is configured and is operated as described above.

(3) in order to normally sort the packet into the communication path B and the communication path D by the conventional packet sorting unit 124, the port number to be set by using the communication path C should be a number different from the port number to be used in a communication application program other than the AV transmission application program.

As a result, the conventional AV data receiver 13 decides a range of a port number used by the AV transmission client APP 107 so as to prevent the port from being used by the client APP 108 and the server APP 109. For example, defining port numbers used by the AV transmission client APP 107 as 10001 to 10002, other numbers are decided to be used by other communication application programs such as a client APP 108 (for example, refer to JP-A-2000-235536 (P.10)).

However, according to this method, it is necessary to decide the port number used by all application programs by themselves or to prevent the port number used by the AV transmission client APP 107 from being used by the first interface (I/F) unit 101.

It is general that a server application program designates a port number used by itself at a communication protocol unit via the communication protocol I/F so as to open a communication line because the communication line should be opened. On the other hand, the client application program designates the port number and the IP address of the server application program, of which communication line is desired to be established, via the communication protocol I/F so as to establish the communication line by the communication protocol unit without being conscious of the port number used by itself. However, although the client application program is not conscious of the port number of itself, the communication protocol I/F appropriately assigns the unused port number so as to make the communication protocol unit establish a communication line in practice.

(4) It is general that the communication protocol unit can transmit the IP packet if a destination IP address is known. However, practically, unless a physical address (a MAC address) corresponding to the IP packet is known, the communication protocol unit cannot make the packet reach a communication party.

Resolution of this physical address is carried out by an address resolution protocol (ARP) prepared by the communication protocol unit. The mechanism of address resolution will be illustrated in FIG. 7.

FIG. 7 is a diagram showing the mechanism of a general address resolution by an address resolution protocol (ARP).

An ARP is a protocol, whereby a communication source retrieves the physical address of the communication party, of which IP address is known but physical address is not known. The communication source broadcasts an ARP request packet for searching for the communication party, and the corresponding communication party returns an ARP response packet to the communication source to notify the physical address of itself to the communication source. Receiving the ARP response packet, the transmission source records a correspondence between the IP address and the physical address in an ARP table being managed.

Thereby, resolving the physical address, the communication protocol unit can transmit the IP packet to the communication party.

Conventionally, for example, the address resolution is carried out according to the method described in JP-A-2000-235536 (P.11, FIG. 5).

FIG. 8 is a functional block showing a functional structure of a conventional host computer for resolving a physical address, disclosed in JP-A-2000-235536 (P.11, FIG. 5).

The case of applying the address resolution method described in JP-A-2000-235536 (P.11, FIG. 5) to the AV data receiver 13 shown in FIG. 1 will be assumed.

When the AV transmission client APP 107 does not know the physical address of a device with which communication is performed, a dummy IP packet of the device with which communication is performed is transmitted to the first communication protocol unit 102 via the first I/F unit 101. In the first communication protocol unit 102, the address resolution by the ARP is carried out, and the first communication protocol unit 102 tries to transmit the dummy IP packet by using the communication path B. Here, in the case that the device with which communication is performed is configured so as not to discard the dummy IP packet, in order to stop transmission of the dummy IP packet, a processing unit to discard the dummy IP packet on the communication path B should be provided.

Detecting that the address resolution is carried out by the ARP in the first communication protocol unit 102 from a notification from the ARP or detecting that a desired physical address is obtained by monitoring the ARP table of the first communication protocol unit 102, the AV transmission client APP 107 obtains this physical address. Then, the AV transmission client APP 107 registers the obtained physical address in the ARP table of the second communication protocol unit 122 from the communication path C via the second I/F unit 121. Thus, carrying out the address resolution in the second communication protocol, the AV transmission client APP 107 starts communication by using the communication path C.

As described above, since a high transmission rate is required, the conventional AV networking equipment is configured by the host apparatus and the apparatus for high-speed transmission. Further, a plurality of communication protocols is installed in one device. The device configured in this manner has the following problems.

The fragment reconstruction unit 210 of the conventional packet sorting unit 124 performs the processing for reconstructing the IP fragment packet in order to appropriately decide the communication path to be outputted. The reconstruction function of this packet is a function installed in the IP on the standard base. This results in that the functions installed in the first communication protocol unit 102 and the second communication protocol unit 122 are also installed in the fragment reconstruction unit 210, and the functions are added in a redundant manner.

In addition, the IP fragment packet should be held in the buffer 407 until the reconstruction of the packet is completed, so that this involves a problem such that the buffer 407 cannot be effectively utilized when it is shared with an other device. Further, unless the reconstruction is completed, fragment reconstruction unit 210 does not output the IP fragment packet to the first communication protocol unit 102 or the second communication protocol unit 122, so that this also involves a problem such that reach of the packet to the first communication protocol unit 102 or the second communication protocol unit 122 is always delayed in the case of the IP fragment packet.

In addition, the above-described conventional art further has the following problems.

The ICMP replicating unit 211 of the conventional packet sorting unit 124 cannot determine a communication path of the transmission destination of the received ICMP error message packet. Therefore, replicating the received ICMP error message packet, the ICMP replicating unit 211 outputs this replicated ICMP error message packet to the first communication protocol unit 102 and the second communication protocol unit 122. This results in that the received ICMP error message packet is also outputted to the second communication protocol unit 122 having no relation when abnormalities are generated in the communication line carrying out the data communication by using the first communication protocol unit 102. In addition, an inverse pattern is obviously generated.

Accordingly, it can be said that the ICMP replicating unit 211 carries out the replicating processing of the ICMP error message packet in a redundant manner and uses the processing capability of the CPU. Further, this also has a problem that, when abnormalities frequently occur in the communication line making the data communication by using the first communication protocol unit 102, a processing load is also given to the second communication protocol unit 122 having no relation to have a bad effect on the high-speed transmission.

In addition, according to the above-described conventional art, in order to normally check the port number in the packet sorting unit 124, the port number used in the all application programs should be decided in advance or changing the first I/F unit 101, the port number used by the AV transmission client APP 107 should be prevented from being used. Further, it is general that a normal client application program leaves the decision of the port number to the communication protocol interface and, there is a problem such that, when using the communication application program used in other system in the conventional AV networking equipment, this communication application program should be changed.

Further, according to the above-described conventional art, in order to resolve the physical address used by the second communication protocol unit 122, it is necessary to carry out resolution of the physical address by the first communication protocol unit 102. In addition, the communication to register the resolved address via the communication path C should be carried out. Further, the AV transmission application program of the host apparatus should carry out the operation to transmit the dummy IP packet, and the apparatus for high-speed transmission should carry 25 out the operation to discard the dummy IP packet. Thus, the conventional art has a problem that the AV transmission application program also should use the first communication protocol unit 102 and a problem that the process operated by the host apparatus and the apparatus for high-speed transmission in conjunction with each other should be added.

### SUMMARY OF THE INVENTION

The present invention has been made taking the foregoing problems into consideration and an object of which is to provide a data communication apparatus for performing communication of an IP packet by a plurality of communication protocols, which can reduce generation of an unnecessary configuration and unnecessary processing.

In order to attain the above-described object, a data communication apparatus according to the present invention a data communication apparatus including a first communication protocol unit that performs communication in accordance with a first communication protocol and a second communication protocol unit that performs communication in accordance with a second communication protocol, the apparatus performing communication using an Internet Protocol (IP) packet, wherein the IP packet is made up of a first packet and one or more second packets, the first packet including destination information for specifying whether the IP packet is addressed to the first communication protocol unit or the second communication protocol unit, and the one or more second packets not having the destination information, and

the data communication apparatus includes: a receiving unit that receives an IP fragment packet, which is the first packet or the second packet; a destination information storing unit that stores the destination information; a buffer for storing the second packet; a first packet determining unit that determines whether or not the IP fragment packet is the first packet, and stores the destination information included in the first packet into the destination information storing unit, in the case where the IP fragment packet is the first packet; a sorting unit that outputs the first packet to any one of the first communication protocol unit and the second communication protocol unit on the basis of the destination information; and a second packet control unit that performs one of the following in the case where the IP fragment packet is the second packet, which is determined by the first packet determining unit not to be the first packet: passing the second packet to the sorting unit in the case where the destination information is stored in the destination information storing unit; and storing the second packet into the buffer in the case where the destination information is not stored in the destination information storing unit, wherein, upon receipt of the second packet from the second packet control unit, the sorting unit outputs the second packet to any one of the first communication protocol unit and the second communication protocol unit on the basis of the destination information stored in the destination information storing unit.

Thereby, the data communication apparatus according to the present invention may not provide the reconstruction processing of the IP fragment packet in the packet sorting unit other than the communication protocol unit. Further, receiving a head packet which is the first packet, the data communication apparatus can pass this head packet to the first communication protocol unit or the second communication protocol unit. Thereby, a delay time until the head packet is passed is reduced. In addition, since the destination information related to the destination is stored, a following packet which is the second packet is outputted as being appropriately sorted into the first communication protocol unit or the second communication protocol unit on the basis of the destination information. As a result, the following packet to reach after the head packet reaches may not use the buffer. Briefly, the buffer can be efficiently used.

In addition, the receiving unit may further receive an Internet Control Message Protocol (ICMP) error message packet, and the data communication apparatus may further include: an error packet determining unit that determines whether or not the ICMP error message packet includes error notice destination information for specifying whether the ICMP error message packet is addressed to the first communication protocol unit or the second communication protocol unit; an error output unit that outputs the ICMP error message packet to any one of the first communication protocol unit and the second communication protocol unit on the basis of the error notice destination information, the ICMP error message packet having been determined by the error packet determining unit to include the error notice destination information; and an error replicating unit that replicates the ICMP error message packet, which has been determined by the error packet determining unit not to include the error notice destination information, and outputs one of the resulting two ICMP error message packets to the first communication protocol unit and the other of the two ICMP error message packets to the second communication protocol unit.

Thereby, since the ICMP packet that is required to be replicate is only replicated, a load for processing due to unnecessary packet replication can be reduced. In addition, the first communication protocol unit and the second communication protocol unit can reduce unnecessary load for processing since the number of times to receive the ICMP packet which is not necessary for them is decreased.

In addition, the data communication apparatus according to the present invention may further include an interface that receives a registration request and deletion of a port number used by the first communication protocol unit; a port number deciding unit that decides a port number to be used by the second communication protocol unit; a port number registering unit that requests, via the interface, the first communication protocol unit to register the port number to be used decided by the port number deciding unit; and a port number deleting unit that deletes the port number to be used registered in the first communication protocol unit, in response to a predetermined notice from the second communication protocol unit, wherein the interface may not accept registration of the same port number as the port number registered in the first protocol unit, and the port number to be used may not to be used by the first communication protocol unit, in the case where the port number registering unit has been able to register the port number to be used into the first communication protocol unit.

Thereby, for example, a client application to perform the AV data transmission using the second communication protocol can perform the data communication without being aware of a port number as same as a conventional client application. Further, modification to limit the port number is not needed in an interface with the first communication protocol unit.

In addition, the data communication apparatus according to the present invention may further include an ARP request receiving unit that receives an Address Resolution Protocol (ARP) request packet to request for resolution of a physical address of an other device, the ARP request packet being transmitted from the first communication protocol unit or the second communication protocol unit; an ARP information storing unit that stores transmission source information, which indicates a transmission source, and a transmission destination address, which is an IP address of the other device in a state where the transmission source information and the transmission destination address are associated with each other, the transmission source information and the transmission destination address being obtained from the ARP request packet received by the ARP request receiving unit; an ARP transmission unit that transmits the ARP request packet to the other device; an ARP response receiving unit that receives an ARP response packet transmitted from the other device in response to the ARP request packet; a response output determining unit that determines an output destination of the ARP response packet based on the IP address of the other device and the transmission destination address, the IP address of the other device being obtained from the ARP response packet received by the ARP response receiving unit, and the transmission destination address being stored in the ARP information storing unit; and a response output unit that outputs the ARP response packet to any one of the first communication protocol unit and the second communication protocol unit in accordance with a result of the determination made by the response output determining unit.

Thereby, for example, in an AV data transmitter configured by a host apparatus having the first communication protocol unit and a apparatus for high-speed transmission having the second communication protocol unit, without adding- a function and processing to the host apparatus, further, without using the first communication protocol unit by the AV data transmitter using the second communication protocol unit, it is possible to resolve a physical address requested by the first communication protocol unit and the second communication protocol unit.

Further, the present invention is realized as a method employing characteristic constituent elements of the data communication apparatus according to the present invention as a step; is realized by a program including these steps, is realized by a recording medium such as a CD-ROM having the program stored, and is also realized by an integrated circuit. The program can be distributed through a transmission medium such as a communication network.

The present invention can provide a data communication apparatus that is required to perform communication at a high transmission rate, which reduces generation of unnecessary structures and unnecessary processing.

As described above, according to the present invention, in the AV data transmitter having a plurality of communication protocols in the host apparatus and the apparatus for high-speed transmission, the fragment packet can be processed without having to provide the function of reconstruction processing of the IP fragment packet both in the apparatus for high-speed transmission and in the communication protocol. Further, a delay until the packet is passed is reduced since the packet is passed when the head packet is received. As a result, the buffer can be efficiently used. Then, in reception of the ICMP packet, only an ICMP packet that is required to be replicated can be replicated, so that a load for processing due to unnecessary packet replication can be reduced. In addition, without modifying a communication protocol interface, it is possible for the client application to perform AV data transmission not to be aware of a port number as same as the conventional client application. Further, in the address resolution of the communication protocol, the processing to operate the host apparatus and the apparatus for high-speed transmission in conjunction with each other is not required, and further, the address can be resolved even if the AV transmission application does not use the first communication protocol unit 102.

Other advantages of the present invention will be described in detail below with reference to the embodiment of the present invention to be described later and the drawings.

Further Information about Technical Background to this Application

The disclosure of Japanese Patent Application No. 2005-289089 filed on Sep. 30, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is functional block diagram showing functional structures of a conventional AV data transmitter and AV data receiver;

FIG.2A is a diagram showing an example of a flow of the processing from generation of an IP fragment until reconstruction of an IP fragment packet;

FIG. 2B is a diagram showing an example of an IP fragment packet;

FIG. 3 is a diagram showing the outline of the processing when the IP fragment packet cannot be reconstructed;

FIG. 4 is a functional block showing a functional structure of a conventional fragment reconstruction unit;

FIG. 5A is a view showing an IP header format;

FIG. 5B is a view showing a correspondence between a value of a PROTOCOL area included in the IP header and a protocol name;

FIG. 5C is a view showing a correspondence between a bit of a FLAGS area included in the IP header and a meaning thereof;

FIG. 6 is a functional block diagram showing a functional structure of a conventional ICMP replicating unit;

FIG. 7 is a diagram showing the mechanism of a general address resolution by an address resolution protocol (ARP);

FIG. 8 is a functional block showing a functional structure of a conventional host computer for resolving a physical address, disclosed in JP-A-2000-235536 (P.11, FIG. 5);

FIG. 9 is a functional block diagram showing functional structures or an AV data transmitter and an AV data receiver according to a first embodiment;

FIG. 10 is a functional block diagram showing a functional structure of a fragment control unit according to the first embodiment;

FIG. 11 is a diagram showing an example of the data structure of the control information, which is stored in a control information staring unit, according to the first embodiment;

FIG. 12A is a diagram showing a TCP header format;

FIG. 12B is a diagram showing a UDP header format;

FIG. 13 is a flow chart showing a flow of the operation of the fragment control unit according to the first embodiment;

FIG. 14 is a functional block diagram showing functional structures of an AV data transmitter and an AV data receiver according to a second embodiment;

FIG. 15 is a functional block diagram showing a functional structure of a fragment control unit and an ICMP monitoring unit according to a second embodiment;

FIG. 16 is a diagram showing a packet format of an ICMP error message;

FIG. 17 is a Functional block diagram showing a functional structure of a fragment control unit according to a third embodiment;

FIG. 18 is a functional block diagram showing a functional structure of a fragment control unit according to a fourth embodiment;

FIG. 19 is a diagram showing an example of the data structure of the control information stored in a control information storing unit according to the fourth embodiment;

FIG. 20 is a functional block diagram showing functional structures of a fragment control unit and an ICMP monitoring unit according to a fifth embodiment;

FIG. 21 is a functional block diagram showing a functional structure of a fragment control unit according to a sixth embodiment;

FIG. 22 is a diagram showing an example of the data structure of the control information stored in a control information storing unit according to the sixth embodiment;

FIG. 23 is a flow chart showing a flow of the operation of a replication control unit according to a seventh embodiment;

FIG. 24 is a flow chart showing a flow of the operation of a replication control unit according to an eighth embodiment;

FIG. 25 is a functional block diagram showing a functional structure of a fragment control unit according to a ninth embodiment;

FIG. 26 is a functional block diagram showing functional structures of an AV data transmitter and an AV data receiver according to a tenth embodiment;

FIG. 27 is a functional block diagram showing a functional structure of an ICMP control unit according to the tenth embodiment;

FIG. 28 is a diagram showing kinds of typical ICMP error messages when the information of an error packet is stored in a DATA area of an ICMP error message packet;

FIG. 29 is a functional block diagram showing functional structures of an AV data transmitter and an AV data receiver according to an eleventh embodiment;

FIG. 30 is a functional block diagram showing a functional structure of a port reservation control unit according to the eleventh embodiment;

FIG. 31 is a functional block diagram showing a functional structure of a port reservation control unit according to a twelfth embodiment;

FIG. 32 is a functional block diagram showing functional structures of an AV data transmitter and an AV data receiver according to a thirteenth embodiment;

FIG. 33 is a functional block diagram showing a functional structure of an ARP monitor control unit according to the thirteenth embodiment;

FIG. 34 is a diagram showing a data constructional example stored in the ARP information storing unit according to the thirteenth embodiment;

FIG. 35 is a diagram showing a packet format of an ARP packet;

FIG. 36 is a functional block diagram showing a functional structure of an ARP monitor control unit according to a fourteenth embodiment;

FIG. 37 is a functional block diagram showing a functional structure of an ARP monitor control unit according to a fifteenth embodiment; and

FIG. 38 is a functional block diagram showing functional structures of an AV data transmitter 10 and an AV data receiver 13 having a plurality of constituent elements characterized in the present invention.

### DESCRIPTION OF THE PREFERRED EMBODIMENTS

Embodiments of the present invention will be described hereinafter with reference to the drawings.

### First Embodiment

As a first embodiment of the present invention, an embodiment, which enables an effective usage of a buffer upon receipt of an IP fragment packet, will be described below.

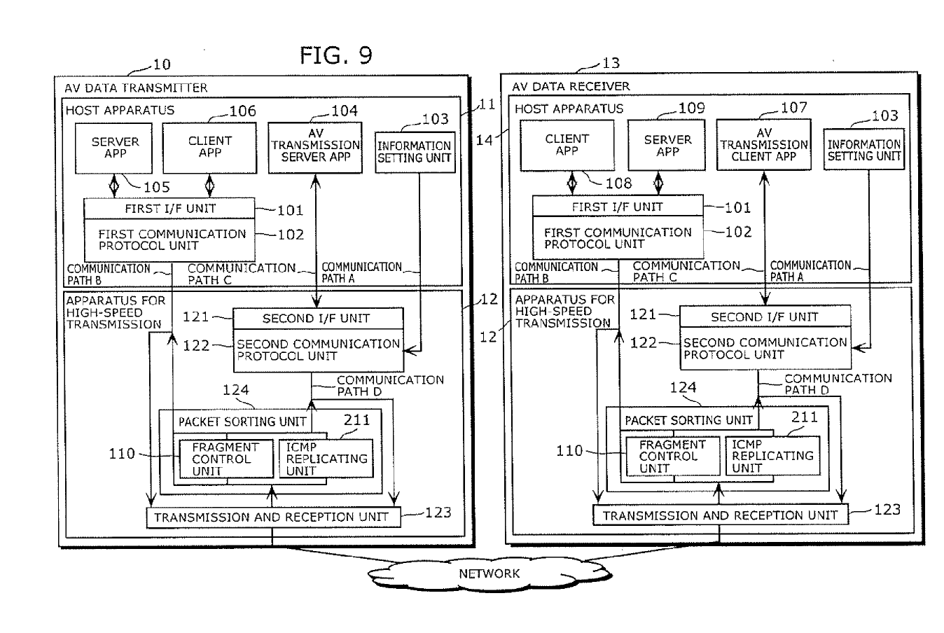

The first embodiment according to the present invention will be described with reference to FIG. 9 to FIG. 13.

FIG. 9 is a functional block diagram showing functional structures of an AV data transmitter 10 and an AV data receiver 13 according to a first embodiment.

Each of the AV data transmitter 10 and the AV data receiver 13 is an example of the data communication apparatus according to the present invention. Specifically, the AV data transmitter 10 and the AV data receiver 13 are made by a DVD recorder having a function to transmit the AV contents through a network and a digital TV having the function to receive the AV contents through network transmission and reproducing it or the like.

Illustration and description about constituent elements originally provided to the AV data transmitter 10 and the AV data receiver 13 such as a function to accumulate the AV contents or the like are herein omitted, and only characteristic constituent elements of the present invention are illustrated and described. The same applies to embodiments 2 to 16 to be described later.

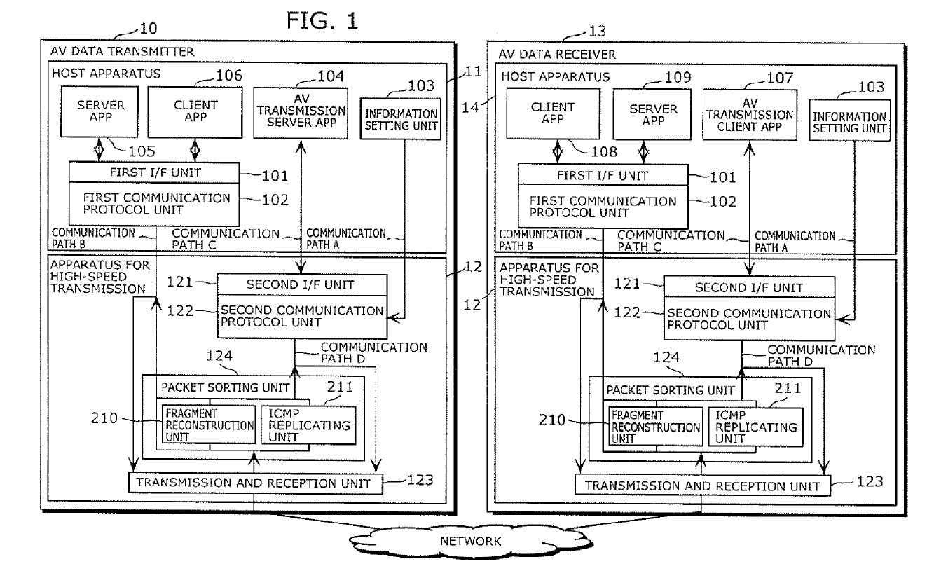

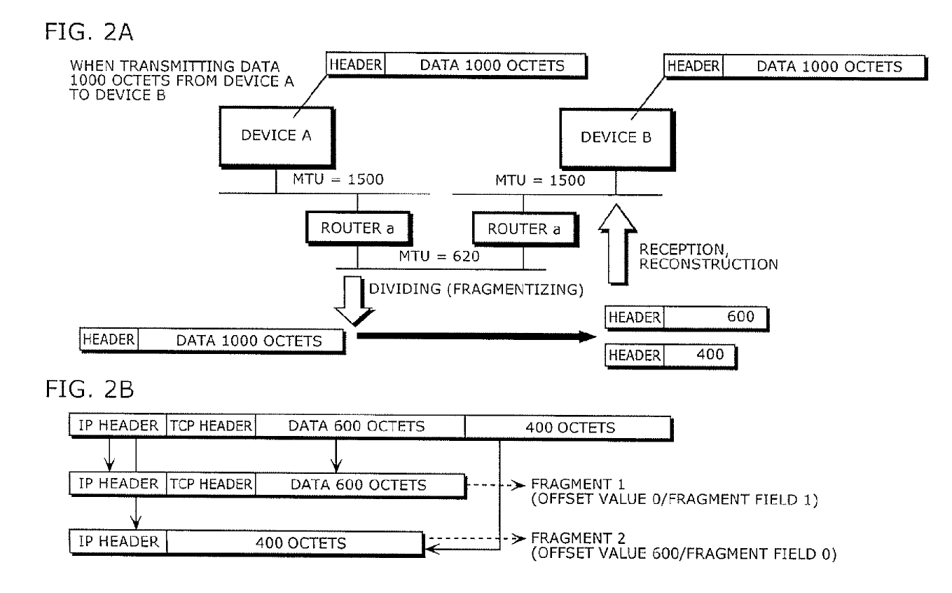

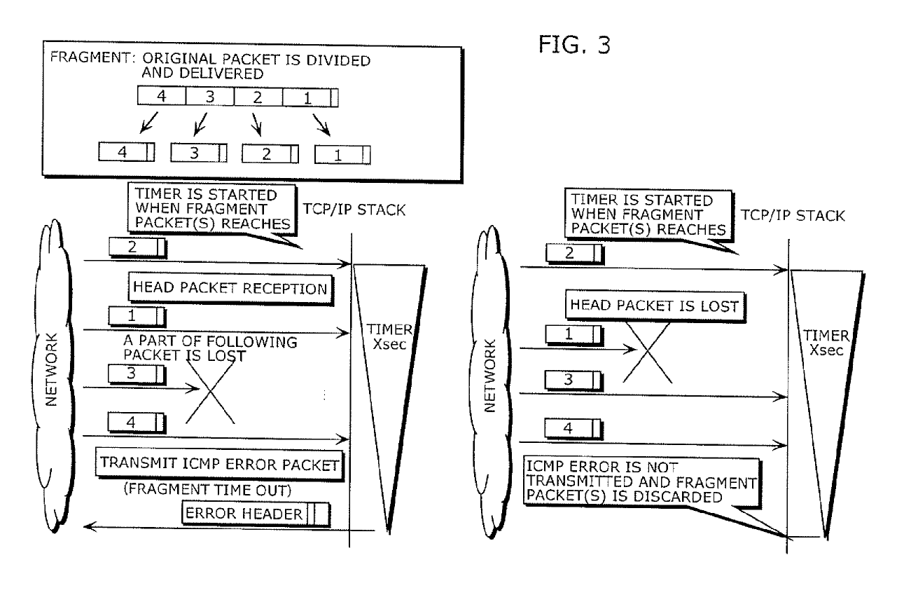

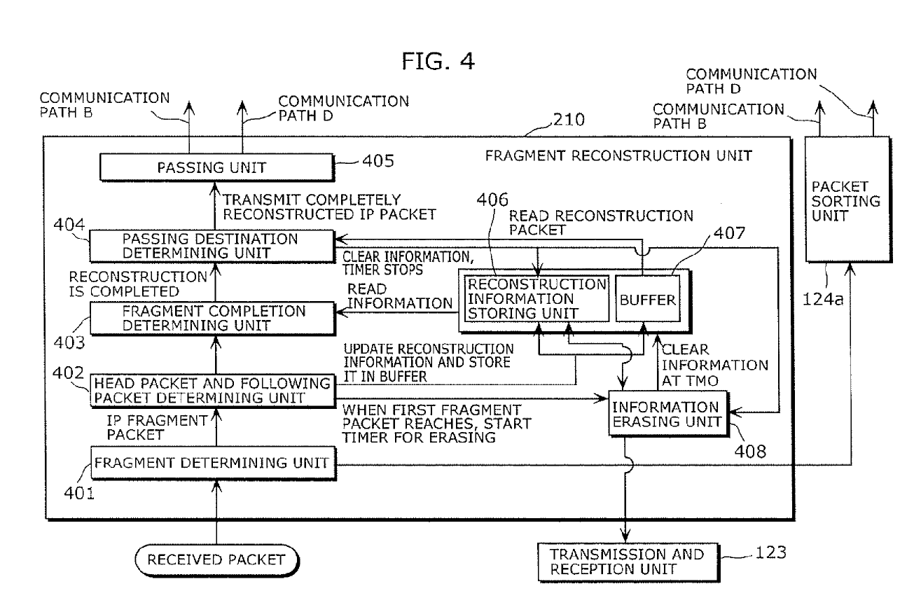

As shown in FIG. 9, as compared to the conventional AV data transmitter 10 and the AV data receiver 13 shown in FIG. 1, the AV data transmitter 10 and the AV data receiver 13 according to the first embodiment are characterized by having a fragment control unit 110 in a packet sorting unit 124. The fragment control unit 110 is a processing unit to efficiently process the received IP fragment packet depending on whether this received IP fragment packet is a head packet or a following packet.

The head packet is an example of the first packet in the data communication apparatus according to the present invention, and the following packet is an example of the second packet in the data communication apparatus according to the present invention.

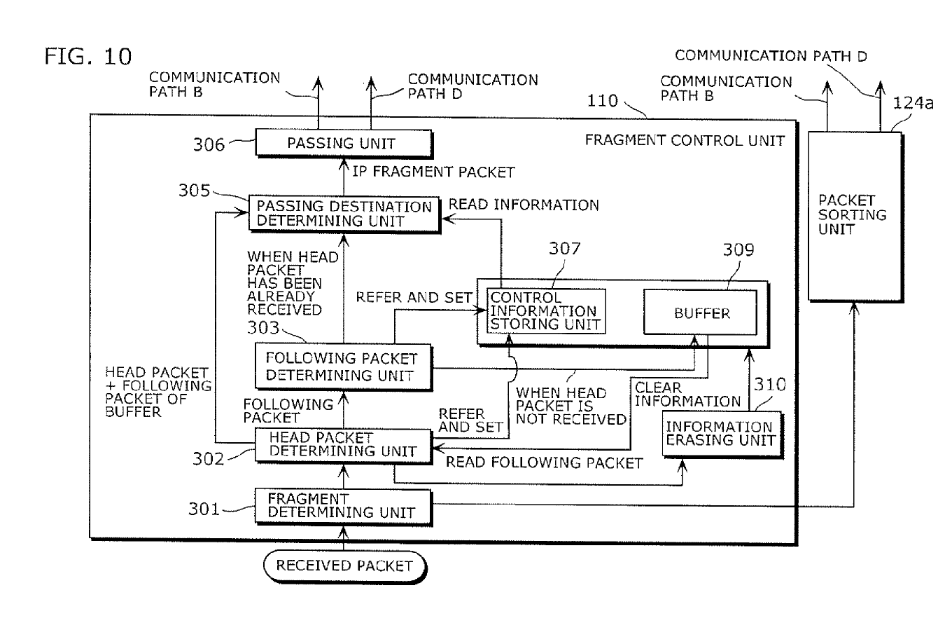

FIG. 10 is a functional block diagram showing a functional structure of a fragment control unit 110 according to the first embodiment. A packet sorting unit 124a in the drawing is a functional block representing a function in the packet sorting unit 124 other than the function of the fragment control unit 110.

The fragment control unit 110 controls transmission to a communication protocol unit of the IP fragment packet on the basis of the control information stored in a control information storing unit 307.

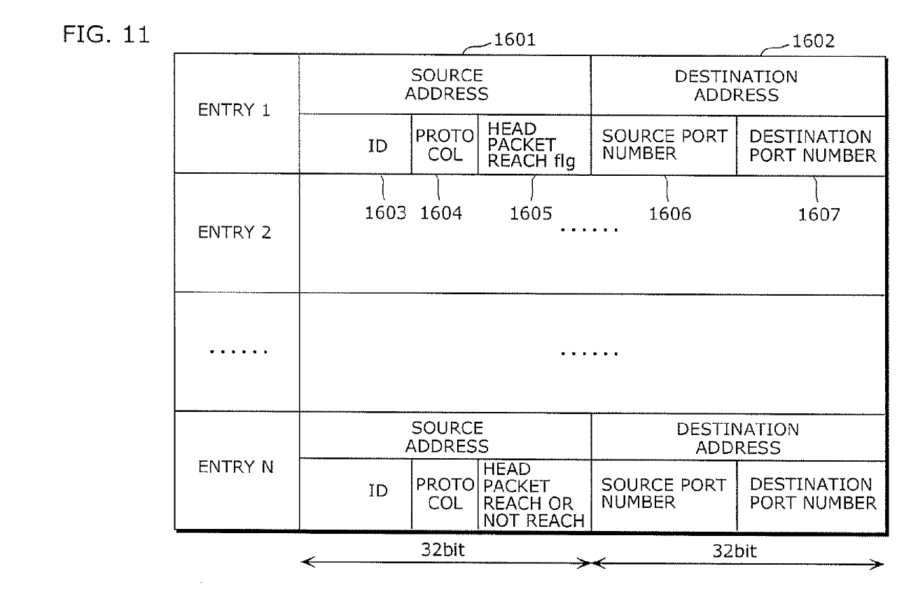

FIG. 11 is a diagram showing an example of the data structure of the control information, which is stored in the control information storing unit 307, according to the first embodiment. How to use the control information will be given in explanation of the operation to be described later.

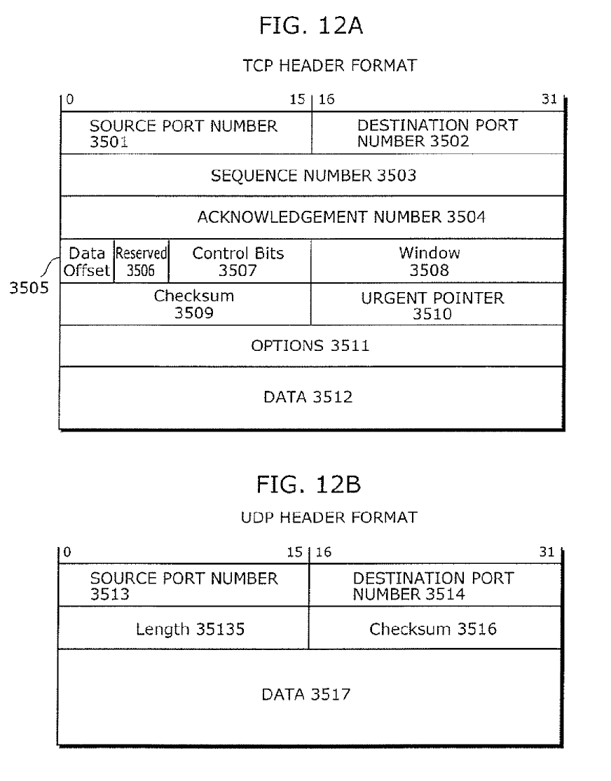

FIG. 12A is a diagram showing a TCP header format, and FIG. 12B is a diagram showing a UDP header format.

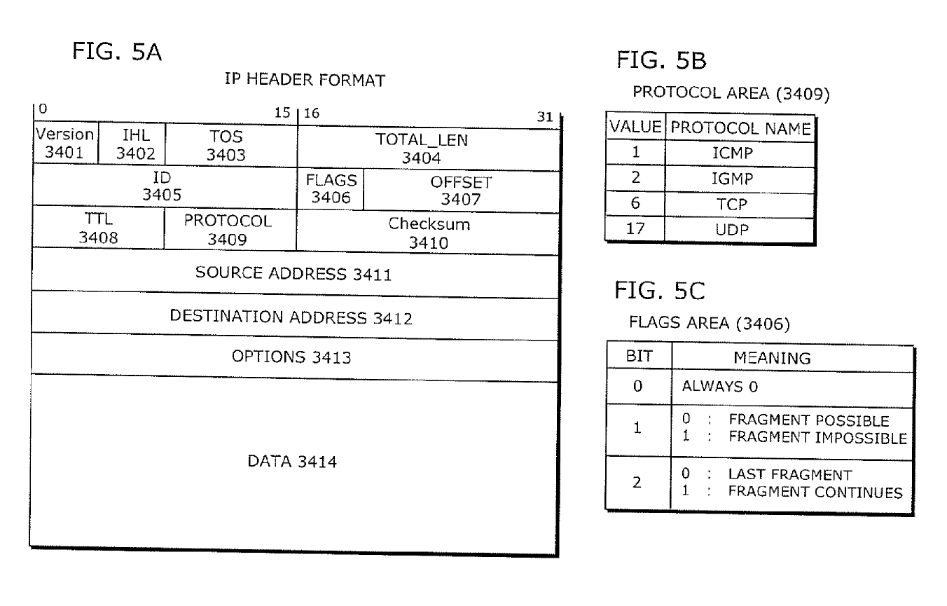

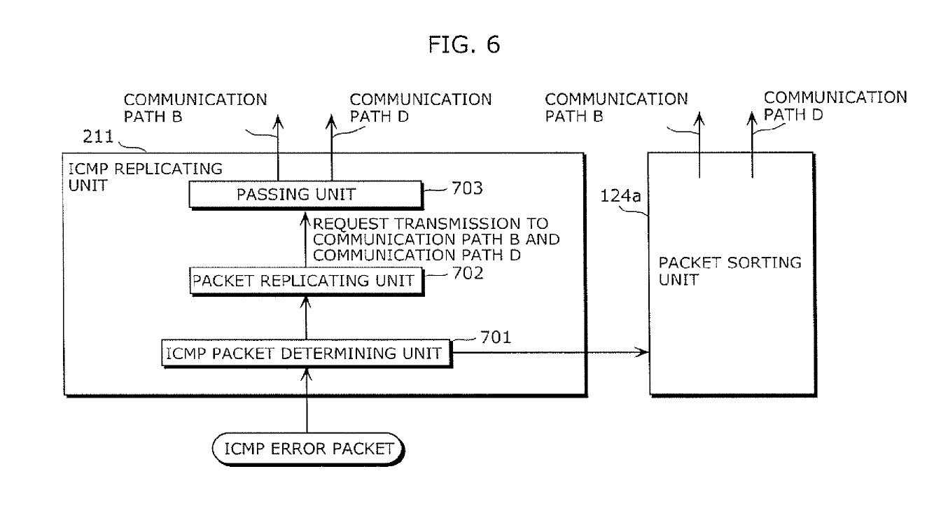

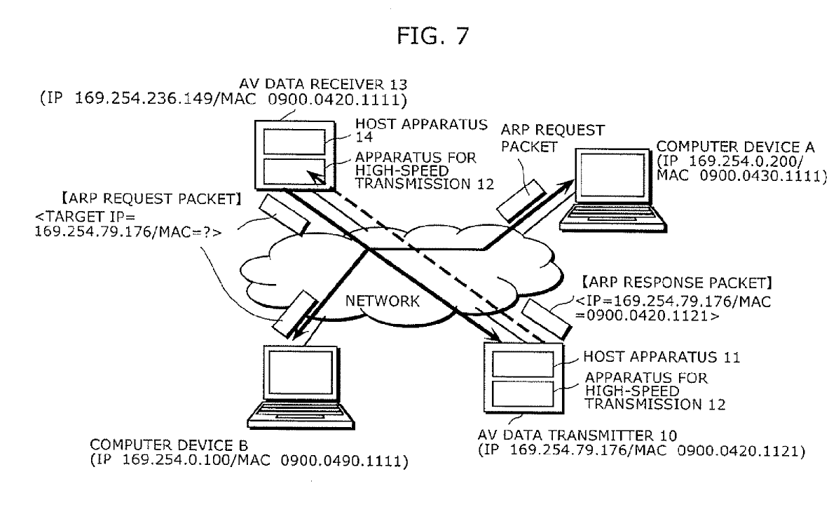

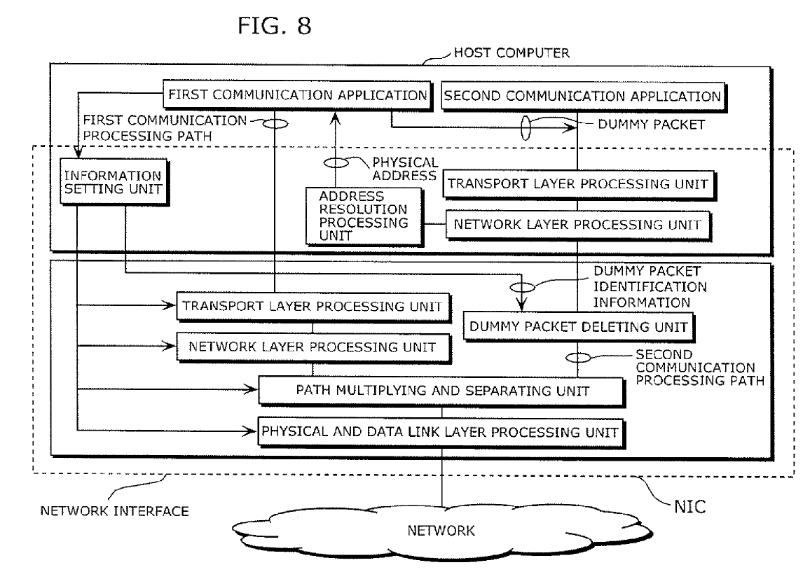

In a DATA 3414 in an IP header format (refer to FIG. 5A), which is a format of a received packet, a TCP header or a UDP header or the like shown in FIG. 12A and FIG. 12B are stored as payload data.

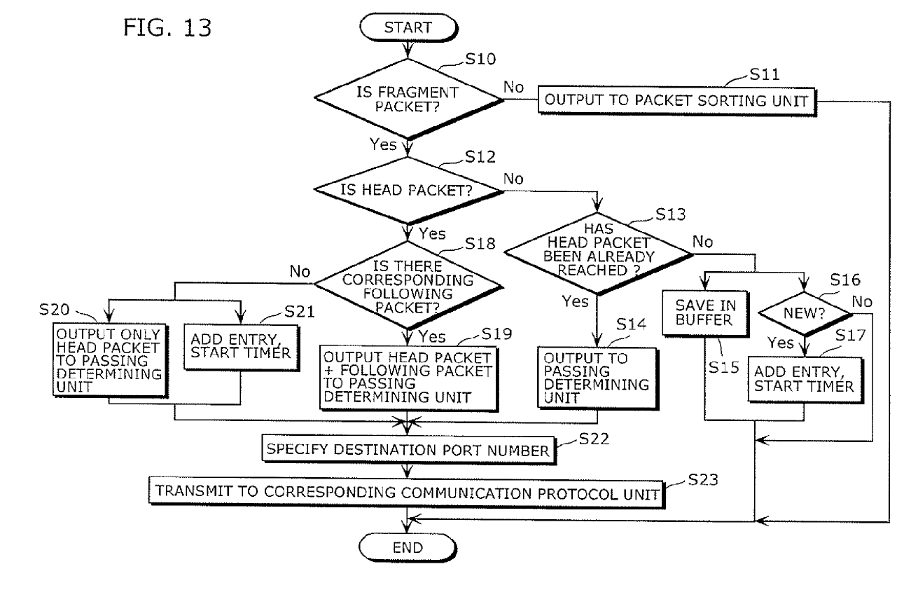

FIG. 13 is a flow chart showing a flow of the operation of the fragment control unit 110 according to the first embodiment. With reference to FIG. 13, the operation of each constituent element of the fragment control unit 110 will be described below.

At first, receiving a packet from a network via a transmission and reception unit 123, a received packet is inputted to a fragment determining unit 301.

The fragment determining unit 301 determines whether the received packet is an IP fragment packet or not. When the received packet is not the IP fragment packet (No at S10), the packet is sorted to an appropriate communication path thereafter by outputting the received packet to a packet sorting unit 124a (S11).

When the received packet is the IP fragment packet (Yes at S10), the received packet is outputted to a head packet determining unit 302.

The head packet determining unit 302 determines whether the inputted received packet is a head packet or not. The head packet determining unit 302 is an example of the first packet determining unit of the data communication apparatus according to the present invention. A method to determine whether the inputted received packet is the head packet or not is a general IP specification, so that the explanation thereof is herein omitted.

When the received packet is a following packet (No at S12), the head packet determining unit 302 outputs an IP fragment packet, which is this received packet, to a following packet determining unit 303. With reference to the control information stored in a control information storing unit 307, the following packet determining unit 303 checks whether the head packet corresponding to this IP fragment packet reached before or not. This check is carried out on the basis of the control information stored in the control information storing unit 307. The head packet determining unit 302 is an example of the second packet control unit in the data communication apparatus according to the present invention,

In the control information storing unit 307, the control information shown in FIG. 11 is stored. The control information storing unit 307 is one example of the destination information storing unit in the data communication apparatus according to the present invention, and the control information is one example of the destination information in the data communication apparatus according to the present invention.

The control information is configured by one or more entries.

One entry is configured by: each information such as SOURCE ADDRESS 1601, DESTINATION ADDRESS 1602, ID1603, and PROTOCOL 1604 which are IP header parameters; a head packet reach flg 1605, which is a flag showing whether a head packet has reached or not; a source port number 1606; and a destination port number 1607.

With each reception of the IP fragment packet, the following 25 packet determining unit 303 compares SOURCE ADDRESS 3411, DESTINATION ADDRESS 3412, and ID 3405, which are located in the IP header parameter, with each entry. As a result of this comparison, when there is an entry with which the above-described three kinds of information match and the head packet reach flg 1605 so indicates reach, the following packet determining unit 303 determines that the head packet corresponding to the received IP fragment packet has been already reached (Yes at S13).

In this way, it is possible to confirm that the head packet has been reached. The above-described check method is an example and the present embodiment is not limited to this method. For example, in the case that a destination port number as the information only located in the head packet but not located in a following packet is registered in an entry with which the above-described three kinds of information match, it may be determined that the head packet has been reached.

Checking that the head packet reached before (Yes at S13), the following packet determining unit 303 outputs a received packet to a passing destination determining unit 305 (S14). In addition, if there is no entry to satisfy the above-described condition, checking that the head packet has not reached yet (No at S13), the following packet determining unit 303 saves the received packet in a buffer 309 (S15).

In this case, when the entry of the control information having a combination of SOURCE ADDRESS 3411, DESTINATION ADDRESS 3412, and ID 3405 located in the IP header of the received packet is not located in the control information storing unit 307, namely, when the received packet is an IP fragment packet that has arrived first (Yes at S16), this received packet is registered as a new entry, and a timer of an information erasing unit 310 is started (for example, 120 seconds).

The information erasing unit 310 has a timer and if a period of time set at the timer (for example, 120 seconds) expires, the information erasing unit 310 erases this entry. Further, the information erasing unit 310 also erases the following packet corresponding to this entry from the buffer 309.

In addition, when the head packet determining unit 302 determines that the received packet is the head packet (Yes at S12), referring to the control information stored in the control information storing unit 307, the head packet determining unit 302 checks whether the following packet corresponding to this head packet is saved in the buffer 309 or not.

This check is carried out on the basis of the control information stored in the control information storing unit 307.

When there is an entry in the control information that the combination of SOURCE ADDRESS 1601, DESTINATION ADDRESS 1602, and ID 1603 matches the combination of the same parameter values in the IP header of the received head packet, the control information storing unit 307 determines that the following packet corresponding to this head packet is saved in the buffer 309 (Yes at S18). Further, the combination of these three pieces of information is an example of the identification information in the data communication apparatus according to the present invention.

In this case, the head packet determining unit 302 outputs not only received head packet but also the all following packets corresponding to this head packet, which are saved in the buffer 309 to the passing destination determining unit 305 (S19). Further, changing the head packet reach FIG. 1605 of this entry into the value indicating reach, the head packet determining unit 302 registers each information in the PROTOCOL 1604, the source port number 1606, and the destination port number 1607.

When the following packet is not saved in the buffer 309, namely, when the entry satisfying the above-described condition is not located in the control information storing unit 307 (No at S18), the head packet determining unit 302 outputs only the received head packet to the passing destination determining unit 305 (S20).

In this case, the head packet determining unit 302 registers a new entry corresponding to this head packet, and starts the timer of the information erasing unit 310 (for example, 120 seconds) (S21).

In this registration, the head packet reach FIG. 1605 is set at a value indicating reach. Further, the SOURCE ADDRESS 1601, the DESTINATION ADDRESS 1602, and the ID1603 are registered in addition to the PROTOCOL 1604, the source port number 1606, and the destination port number 1607.

In this way, the packet held in the received packet or the buffer 309 is outputted to the passing destination determining unit 305 by the head packet determining unit 302 or the following packet determining unit 303.

The passing destination determining unit 305 retrieves an entry having a combination matching a combination of the information of the SOURCE ADDRESS 3411, the DESTINATION ADDRESS 3412, and the ID 3405 of the inputted received packet. Further, specifying a destination port number from the destination port number of the corresponding entry (S22), the passing destination determining unit 305 outputs the specified destination port number and the received packet to a passing unit 306.

The passing unit 306 transmits the packet to a communication patch to the communication protocol unit corresponding to the received destination port number (S23). Specifically, in the case of transmitting the packet to the first communication protocol unit 102, the passing unit 306 transmits the packet to a communication path B, and in the case of transmitting the packet to the second communication protocol unit 122, the passing unit 306 transmits the packet to a communication path D. In this way, a sorting unit of the data communication apparatus of the present invention is realized by the passing destination determining unit 305 and the passing unit 306.

As described above, the AV data transmitter 10 and the AV data receiver 13 of the first embodiment have the fragment control unit 110. The fragment control unit 110 determines whether the received IP fragment packet is a head packet or not. If the received IP fragment packet is the head packet, this packet will be transmitted to the communication protocol unit, which is the destination.

In this case, the following packet corresponding to this head packet stored in the buffer 309 will be transmitted together with the head packet.

In other words, although the following packet is held in the buffer 309 until the head packet reaches, if the head packet reaches, this is transmitted to the communication protocol unit of the destination. The following packet to reach after the head packet will be correctly transmitted to the communication protocol unit of the destination since the port number of the destination is stored in the control information storing unit 307.

Conventionally, when sorting certain data, it is necessary to hold all the IP fragment packets configuring the data in the buffer and reconstruct them. Therefore, a buffer with a large capacity is required. However, in the AV data transmitter 10 and the AV data receiver 13 of the first embodiment, it is possible, through an operation of the fragment control unit 110, to reduce the amount of buffer to be temporarily used before certain data reaches the communication protocol unit to the minimum amount that is required to be used when the head packet of such data reaches fragment control unit 110.

In this way, the present invention has an advantage to improve a use efficiency of the buffer. In other words, it is possible to reduce unnecessary processing in use of the buffer.

In addition, it is possible to prevent delay of reach of the packet to the first communication protocol unit 102 and the second communication protocol unit 122.

### Second Embodiment

As a second embodiment according to the present invention, the embodiment such that the unnecessary control information is deleted from the buffer when the first communication protocol unit 102 or the second communication protocol unit 122 transmits a ICMP error message will be described below.

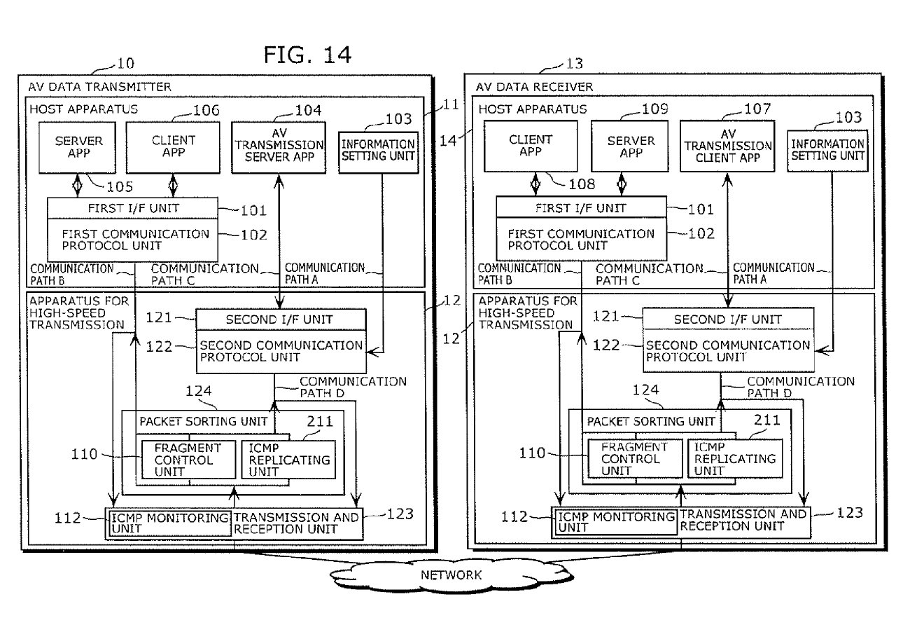

The second embodiment according to the present invention will be described with reference to FIGS. 14 to 16.

FIG. 14 is a functional block diagram showing functional structures of the AV data transmitter 10 and the AV data receiver 13 according to the second embodiment.

As shown in FIG. 14, as compared to the AV data transmitter 10 and the AV data receiver 13 according to the first embodiment shown in FIG. 9, the AV data transmitter 10 and the AV data receiver 13 according to the second embodiment are characterized by having an ICMP monitoring unit 112 in the transmission and reception unit 123. The ICMP monitoring unit 112 is a processing unit to monitor the ICMP error message.

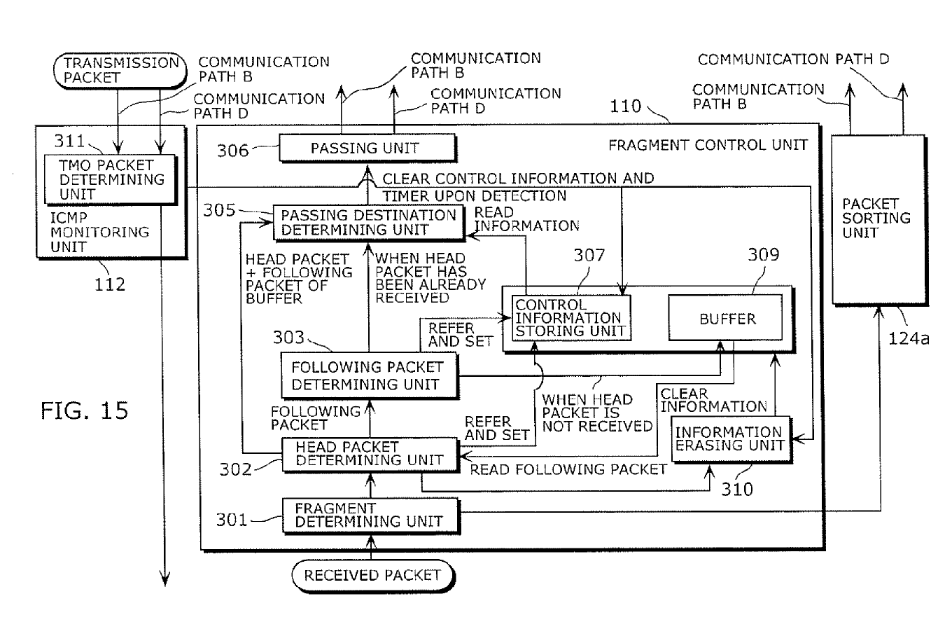

FIG. 15 is a functional block diagram showing a functional structure of a fragment control unit 110 and an ICMP monitoring unit 112 according to the second embodiment. A packet sorting unit 124a in the drawing is a functional block representing a function, in the packet sorting unit 124 other than the function of the fragment control unit 110.

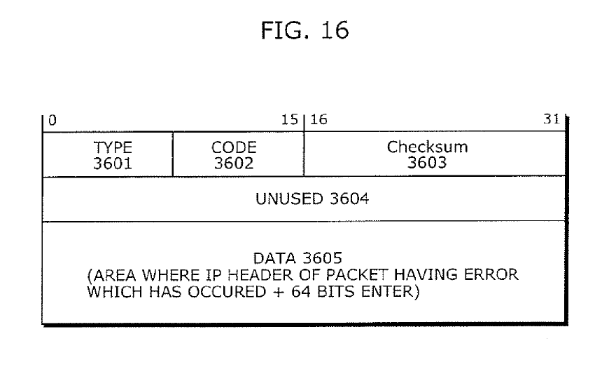

FIG. 16 is a diagram showing a packet format of the ICMP error message. The ICMP error message for fragment time out (Time Exceeded Code=1) is also the present format, and the packet format of the ICMP error message is identified because “11” is set in a type 3601 and “1” is set in a code 3602.

In addition, in DATA 3605, the information related to the packet where an error is generated is stored. The embodiment using this information will be described later as a tenth embodiment.

The operation of the AV data transmitter 10 and the AV data receiver 13 according to the second embodiment is the operation same as the operation of each device of the first embodiment other than monitoring of a transmission packet. Therefore, only a difference from the first embodiment will be described below.

A packet transmitted from the first communication protocol unit 102 or the second communication protocol unit 122 is inputted to the transmission and reception unit 123 via the communication path B or the communication path D. The operation of the ICMP monitoring unit 112 in this case will be described. Further, the packet transmitted from the first communication protocol unit 102 or the second communication protocol unit 122 is referred to as a transmission packet.

A time out (hereinafter, also referred to as “TMO”) determining unit 311 in the ICMP monitoring unit 112 checks whether the transmission packet is the ICMP error message for fragment time out (Time Exceeded code=1) or not. If it is the ICMP error message for fragment time out, the ICMP monitoring unit 112 analyzes the contents of DATA 3605 of this message. Further, the TMO determining unit 311 is an example of the time out detecting unit in the data communication apparatus according to the present invention.

In the DATA 3605, the information of the head packet, which failed reconstruction of fragment, is stored. This stored information is an IP header format shown in FIG. 5A. When the format of the TCP header or the UDP header shown in FIG. 12A and FIG. 12B is stored in the DATA 3414, the THO determining unit 311 refers to the information of the SOURCE ADDRESS 3411, the DESTINATION ADDRESS 3412, and the ID 3405.

Next, the TMO packet determining unit 311 checks whether an entry having a combination of the information matching a combination of the above-described information is located in the control information storing unit 307 or not. If there is such an entry, all information of this entry is cleared into 0. With regard to the entry, after stopping the timer of information erasing unit 310 (for example, 120 seconds), TMO packet determining unit 311 transmits the transmission packet to the network. In addition, if the entry satisfying the above-described condition is not located in the control information storing unit 307, the TMO packet determining unit 311 transmits the transmission packet as it is to the network.

In this way, according to the second embodiment, not only the information erasing unit 310 but also the TMO packet determining unit 311 can erase the control information. Specifically, the TMO packet determining unit 311 detects that the ICMP error message packet has been transmitted by the first communication protocol unit 102 or the second communication protocol unit 122. The fact that the ICMP error message packet has been transmitted means that the control information about the received packet corresponding to this message is unnecessary, so that the TMO packet determining unit 311 deletes the control information. Thereby, the buffer 309 can be effectively utilized.

Further, according to the instruction of the TMO packet determining unit 311, the information erasing unit 310 may erase the unnecessary control information.

### Third Embodiment

As a third embodiment according to the present invention, the embodiment considering setting of a value of a timer suitable for discard of the IP fragment packet will be described.

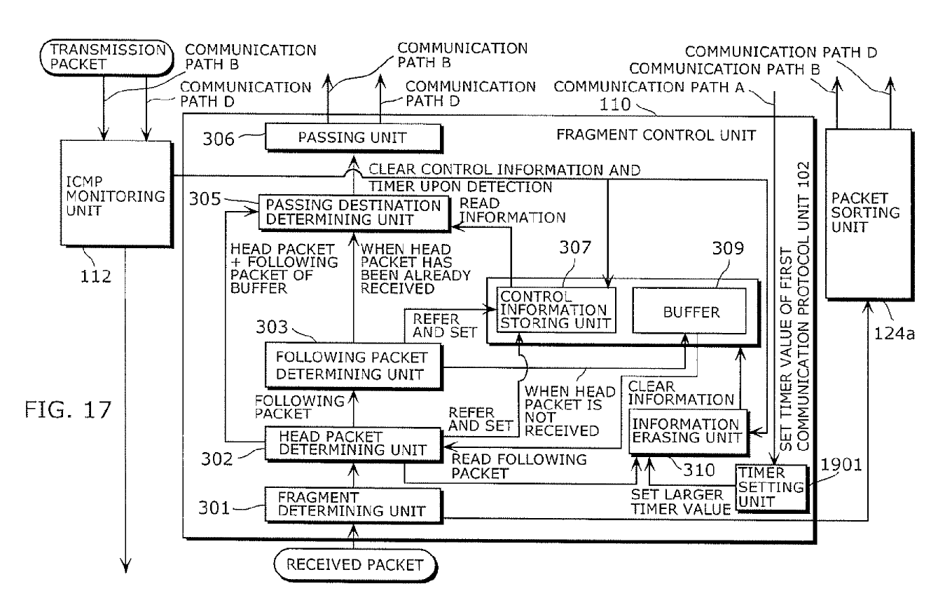

The third embodiment according to the present invention will be described with reference to FIG. 17.

FIG. 17 is a functional block diagram showing a functional structure of a fragment control unit 110 according to the third embodiment. A packet sorting unit 124a in the drawing is a functional block representing a function in the packet sorting unit 124 other than the function of the fragment control unit 110.

The third embodiment is an embodiment that the fragment control unit 110 includes a timer setting unit 1901. The timer setting unit 1901 obtains a timer value set in the first communication protocol unit 102 via the communication path A, and compares this value with the timer value set in the information erasing unit 310 (for example, 120 seconds). As a result of comparison, a larger one is used by the information erasing unit 310. Other processes are the same as the first embodiment,

According to the third embodiment, when the timer value set in the second communication protocol unit 122 is set in the information erasing unit 310, it is possible to compare the timer value set in the first communication protocol unit 102 with the timer value set in the second communication protocol unit 122.

As a result of this comparison, by employing a larger timer value, the information erasing unit 310 can operate with a timer value including a period of time for time out required of the first communication protocol unit 102 and a period of time for time out required of the second communication protocol unit 122. As a result, even when an apparatus for high-speed transmission 12 is connected to any host apparatus, it is possible to cause the information erasing unit 310 to operate using an appropriate timer value without modifying the apparatus for high-speed transmission 12.

Generally, it is required to connect the apparatus for high-speed transmission to the host apparatuses of various AV networking equipment. Therefore, the first communication protocol unit 102 is different for each host apparatus, and it is obvious that each of the above-described timer values is different. Thus, by having the structure of the third embodiment, the apparatus for high-speed transmission 12 can be configured so as to be generalized and be suitable for mass production in a simple way.

### Fourth Embodiment

As a fourth embodiment according to the present invention, another embodiment considering setting of a value of a timer suitable for discard of the IP fragment packet will be described.

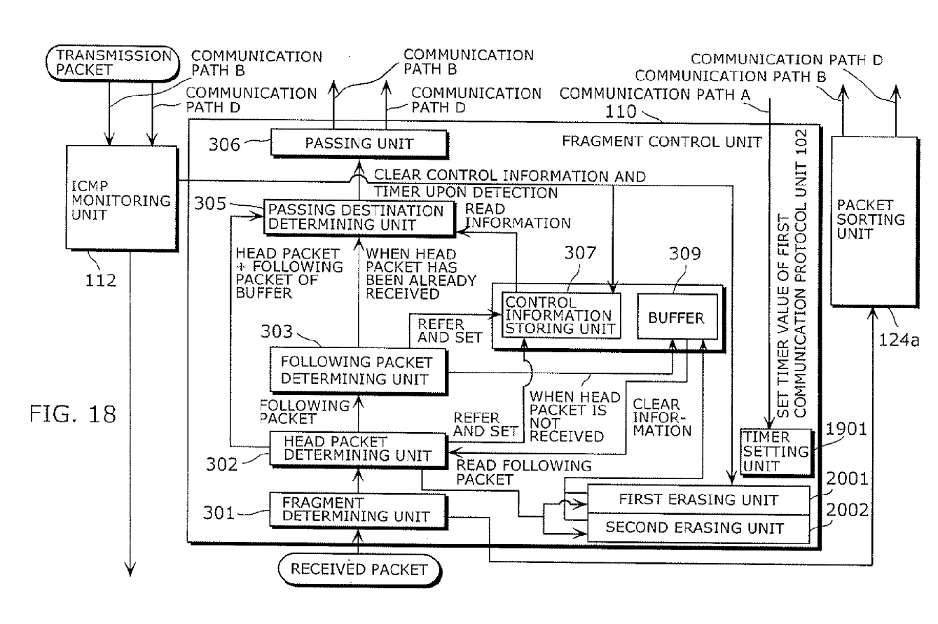

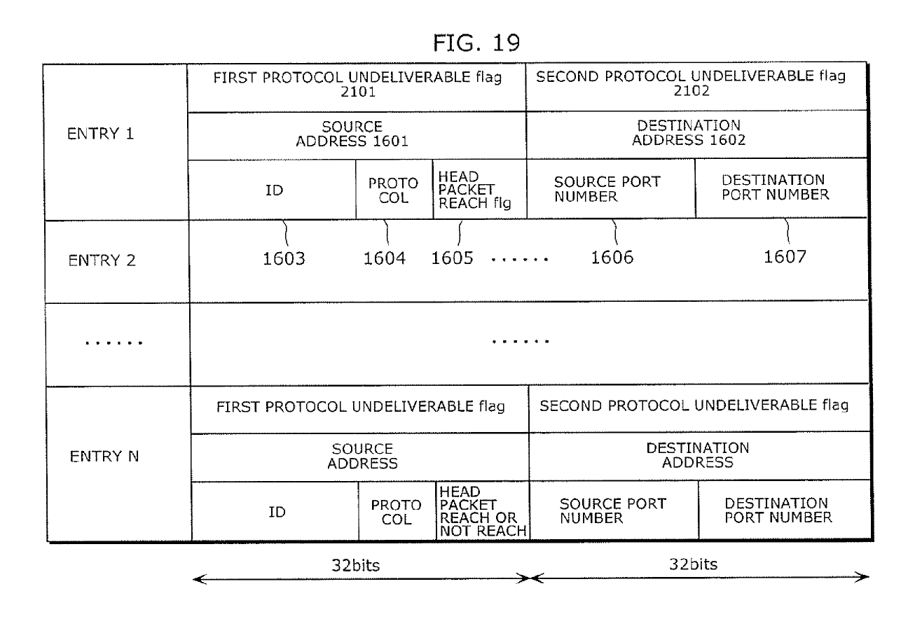

The fourth embodiment according to the present invention will be described with reference to FIG. 18 and FIG. 19.

FIG. 18 is a functional block diagram showing a functional structure of a fragment control unit 110 according to the fourth embodiment. A packet sorting unit 124a in the drawing is a functional block representing a function in the packet sorting unit 124 other than the function of the fragment control unit 110.

As shown in FIG. 18, the fragment control unit 110 according to the fourth embodiment is configured in such a manner that a first erasing unit 2001 and a second erasing unit 2002 are arranged in place of the information erasing unit 310 of the fragment control unit 110 according to the third embodiment.

The first erasing unit 2001 and the second erasing unit 2002 have a timer, respectively (not illustrated), so that they can set a different timer value for each timer.

Specifically, in the first erasing unit 2001, a timer value for the first communication protocol unit 102 is set, and in the second erasing unit 2002, a timer value for the second communication protocol unit 122 is set. A method for obtaining a timer value of the first communication protocol unit 102 is the same as that of the third embodiment.

FIG. 19 is a diagram showing an example of the data structure of the control information stored in the control information storing unit 307 according to the fourth embodiment. A first protocol undeliverable flag 2101 is a management information area where a flag value indicating that the data is not required to be sorted to the first communication protocol unit 102 is set. A second protocol undeliverable flag 2102 is a management information area where a flag value indicating that the data is not required to be sorted to the second communication protocol unit 122 is set. Upon initiation, each flag takes a value indicating that the data can be passed.

Further, the flag value to be set in the first protocol undeliverable flag 2101 is an example of the first historical information in the data communication apparatus of the present invention, and the flag value to be set in the second protocol undeliverable flag 2102 is an example of the second historical information in the data communication apparatus of the present invention.

In the fourth embodiment, the above-described two timers are started at the same time from a registered point for each entry shown in FIG. 19. When the timer of the first erasing unit 2001 or the second erasing unit 2002 expires, a value indicating that the data cannot be passed is set in the first protocol undeliverable flag 2101 or the second protocol undeliverable flag 2102 corresponding to each erasing unit. As a result, when both flags indicate that the data cannot be passed, the first erasing unit 2001 or the second erasing unit 2002 erases the corresponding entry.

In the processing upon receipt of the packet, different parts from the first to third embodiment will be described below.

The passing destination determining unit 305 retrieves an entry having a combination of information matching a combination of the information of the SOURCE ADDRESS (3411), the DESTINATION ADDRESS (3412), and the ID (3405) of the inputted packet and specifies it The passing destination determining unit 305 outputs the destination port number read from the destination port number 1607 of the specified entry and the packet to the passing unit 306.

In this case, the passing destination determining unit 305 outputs the destination port number and the packet to the passing unit 306 together with the value of the first protocol undeliverable flag 2101 or the second protocol undeliverable flag 2102.

The passing unit 306 sorts the packet to the communication path to the communication protocol unit corresponding to the destination port number.

Specifically, when the value of the first protocol undeliverable flag 2101 indicates that the packet is undeliverable, and when the communication path having the data sorted thereto is the communication path B, namely, when the destination of the packet is the first communication protocol unit 102, this packet is discarded. In the same way, when the value of the second protocol undeliverable flag 2102 indicates that the packet is undeliverable, and when the communication path to which the data is sorted is the communication path D, namely, the destination of the packet is the second communication protocol unit 122, this packet is discarded.

In this way, according to the fourth embodiment, the passing unit 306 does not pass the IP fragment packet to the communication protocol unit where time out has been already generated at a point of time when the head packet reaches. Accordingly, preventing unnecessary copy processing and communication processing, a load of processing can be reduced.

### Fifth Embodiment

As a fifth embodiment according to the present invention, the embodiment for automatically measuring a timer value of the first communication protocol unit 102 will be described below.

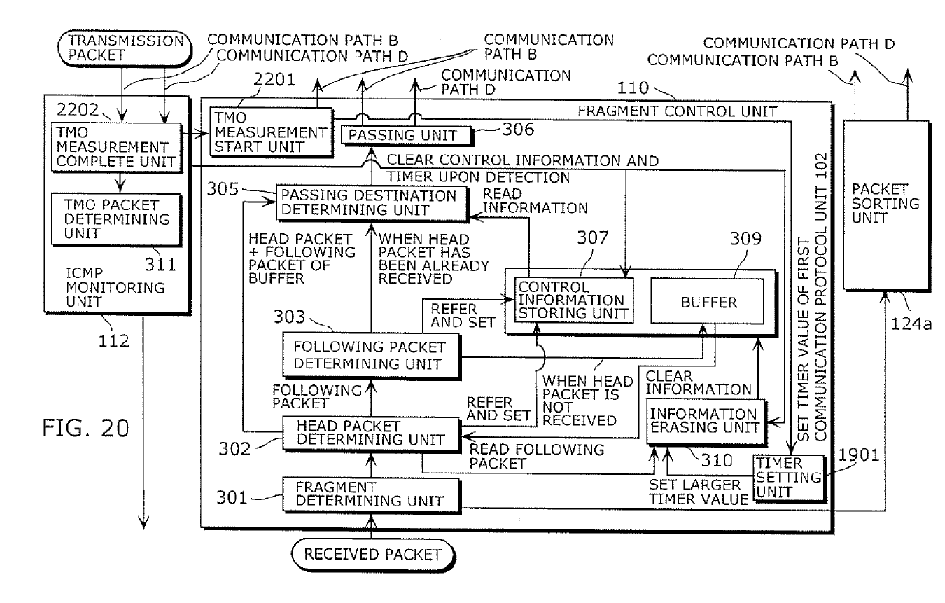

With reference to FIG. 20, the fifth embodiment according to the present invention will be described.

FIG. 20 is a functional block diagram showing functional structures of the fragment control unit 110 and the ICMP monitoring unit 112 according to a fifth embodiment. A packet sorting unit 124a in the drawing is a functional block representing a function in the packet sorting unit 124 other than the function of the fragment control unit 110.

As shown in FIG. 20, the fragment control unit 110 and the ICMP monitoring unit 112 according to a fifth embodiment are configured in such a manner that a TMO measurement start unit 2201 is added to the fragment control unit 110 according to the third embodiment and the TMO packet determining unit 311 and a TMO measurement complete unit 2202 are added to the ICMP monitoring unit 112, respectively.

By providing the TMO measurement start unit 2201 and the TMO measurement complete unit 2202 to the apparatus for high-speed transmission 12 of the AV data transmitter 10 and the apparatus for high-speed transmission 12 of the AV data receiver 13, the AV data transmitter 10 can measure the timer value of the host apparatus 11 and the AV data receiver 13 can measure the timer value of the host apparatus 14.

The operations of the TMO measurement start unit 2201 and the TMO measurement complete unit 2202 will be described below. Further, the TMO measurement start unit 2201 is an example of the dummy packet output unit in the data communication apparatus according to the present invention. In addition, by the TMO measurement start unit 2201 and the TMO measurement complete unit 2202, a time out measuring unit in the data communication apparatus according to the present invention is realized.

At first, the TMO measurement start unit 2201 creates a dummy head fragment packet and transmits it to the communication path B. In other words, the TMO measurement start unit 2201 transmits it to the first communication protocol unit 102.

In this case, the TMO measurement start unit 2201 starts the timer in its interior. After that, if arbitrary time has passed, the first communication protocol unit 102, which received only the head fragment, failures in reconstruction of a fragment, and then, the first communication protocol unit 102 transmits the ICMP error message (Time Exceeded code=1) for fragment time out in accordance with a standard of the IP. The TMO measurement complete unit 2202 receives this ICMP error message via the communication path B.

The TMO measurement complete unit 2202 first checks whether this ICMP error message (Time Exceeded code=1) is one for fragment time out or not. Then, if it is the ICMP error message for fragment time out, the TMO measurement complete unit 2202 analyzes the contents of the DATA 3605. As described in the second embodiment, when this stored information is the IP header format shown in FIG. 5A, and the format of the TCP header or the UDP header shown in FIG. 12A or FIG. 12B is stored in the DATA 3414, the information of its SOURCE ADDRESS 3411, DESTINATION ADDRESS 3412, and ID 3405 will be referred. In the case that such information match the information of the head fragment packet of the dummy, the TMO measurement complete unit 2202 notifies the TMO measurement start unit 2201 of completion of measurement. Further, the notifying method may use a signal, interruption, and a command.

Upon receipt of a notification to indicate that measurement is completed, the TMO measurement start unit 2201 stops a timer started when a dummy head fragment packet is transmitted. Further, the TMO measurement start unit 2201 passes a time taken from the TMO measurement start unit 2201 transmitted the dummy head fragment packet until the TMO measurement start unit 2201 receives the notification indicating completion of measurement as a timer value of the first communication protocol unit 102 to the timer setting unit 1901.

According to the fifth embodiment, it is possible to automatically measure a timer value of the first communication protocol unit 102. Generally, the apparatus for high-speed transmission is required to be connected to the host apparatuses of various AV networking equipments. However, the first communication protocol unit 102 can be operated obtaining the timer value of the host apparatus without modifying the host apparatus, specifically, without adding a function to notify the apparatus for high-speed transmission of the timer value.

In other words, without adding a function to the host apparatus unnecessarily, the apparatus for high-speed transmission can know the timer value of the host apparatus.

### Sixth Embodiment

As a sixth embodiment according to the present invention, the embodiment for continuing communication without discard of the following packet even when a vacant capacity of the buffer 309 is left little will be described below.

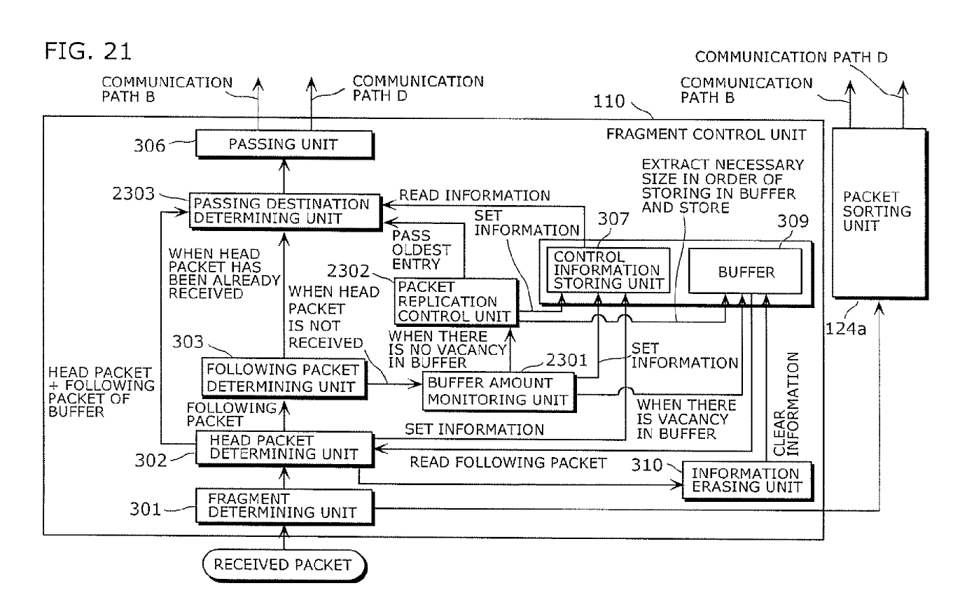

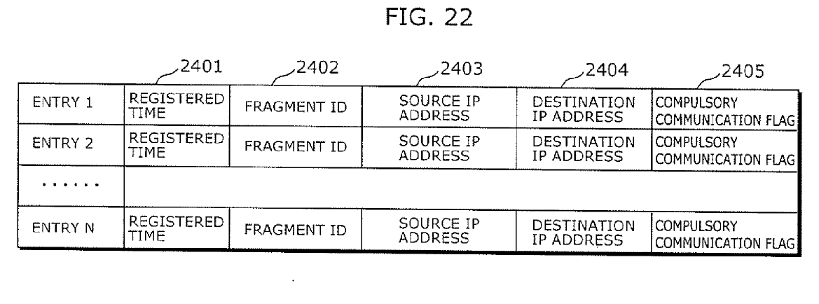

The sixth embodiment of the present invention will be described with reference to FIG. 21 and FIG. 22.

FIG. 21 is a functional block diagram showing a functional structure of the fragment control unit 110 according to the sixth embodiment. A packet sorting unit 124a in the drawing is a functional block representing a function in the packet sorting unit 124 other than the function of the fragment control unit 110.

As shown in FIG. 21, the fragment control unit 110 according to the sixth embodiment is configured by adding a buffer amount monitoring unit 2301 and a packet replication control unit 2302 to the structure of the fragment control unit 110 according to the first embodiment shown in FIG. 10.

Further, the buffer amount monitoring unit 2301 is an example of the capacity detecting unit of the data communication apparatus according to the present invention, and the packet replication control unit 2302 is an example of the packet replicating unit of the data communication apparatus according to the present invention.

FIG. 22 is a diagram showing an example of the data structure of the control information stored in the control information storing unit 307 according to the sixth embodiment.

This control information is the information, which is used by the buffer amount monitoring unit 2301, the packet replication control unit 2302, and a passing destination determining unit 2303.

In the case that the following packet corresponding to each entry is transmitted to the first communication protocol unit 102 and the second communication protocol unit 122 without waiting for reach of the head packet, a flag value indicating a compulsory communication is registered in a compulsory communication flag 2405 included in each entry.

Registration of the compulsory communication flag 2405 and transmission of the following packet are carried out by the buffer amount monitoring unit 2301, the packet replication control unit 2302, and the passing destination determining unit 2303.

At first, the operation of the buffer amount monitoring unit 2301 will be described.

The following packet, which is determined by the following packet determining unit 303 that its head packet is not received, is passed to the buffer amount monitoring unit 2301. Receiving this following packet, the buffer amount monitoring unit 2301 detects a packet length of this following packet and compares this with a vacant capacity of the buffer 309.

In this case, if “the packet length≦the vacant capacity of the buffer 309” is established, the following packet is stored in the buffer 309. In addition, if “the packet length>the vacant capacity of the buffer 309” is established, the buffer amount monitoring unit 2301 outputs the following packet to the packet replication control unit 2302 without storing the following packet in the buffer 309. Further, the buffer amount monitoring unit 2301 registers each information of a registered time 2401, a fragment ID 2402, a source IP address 2403, and a destination IP address 2404.

Next, the operation of the packet replication control unit 2302 will be described.

The packet replication control unit 2302 holds the following packet received from the buffer amount monitoring unit 2301 because it cannot store the received following packet in the buffer 309, and the packet replication control unit 2302 takes out the following packets stored in the buffer 309 in the order of storing them. Further, the taken-out following packet is replicated into the number of communication protocol unit. In other words, according to the present embodiment, one following packet is replicated into two to be outputted to the passing destination determining unit 2303. Further, in this case, the packet replication control unit 2302 sets a flag showing the compulsory communication in the compulsory communication flag 2405 of the entry corresponding to the taken-out following packet. Further, in order to determine the order of storing the following packets in the buffer 309, the registered time 2401 of the control information is used.

This processing will be continued until “the packet length of the following packet received from the buffer amount monitoring unit 2301≦the vacant capacity of the buffer 309” is established. After that, storing the received following packets in the buffer 309, the packet replication control unit 2302 registers the following packet in the control information storing unit 307 as a new entry if there is no entry with which the all information of the registered time 2401, a fragment ID 2402, a source IP address 2403, and a destination IP address 2404 match.

Next, the operation of the passing destination determining unit 2303 will be described.

Receiving the following packet from the packet replication control unit 2302, the passing destination determining unit 2303 reads the entry information corresponding to this following packet from the control information storing unit 307. In this case, if a flag value indicating the compulsory communication is set in the compulsory communication flag 2405, the passing destination determining unit 2303 outputs the received following packet and the request to transmit this following packet to the all communication paths to the passing unit 306. According to the present embodiment, this results in that the passing unit 306 receives the same following packet two by two, and then, this following packet is transmitted to the first communication protocol unit 102 and the second communication protocol unit 122 one by one.

In other words, the following packet corresponding to the entry that the flag value indicating the compulsory communication is set in the compulsory communication flag 2405 will be transmitted to the first communication protocol unit 102 and the second communication protocol unit 122.

In addition, the head packet determining unit 302 and the passing destination determining unit 305 when it received the fragment packet from the following packet determining unit 303 will be operated in accordance with the order of the above-described first to fifth embodiments.

Thus, according to the sixth embodiment, even if the vacant capacity of the buffer 309 is left little, for example, when the condition that the plural fragmented IP fragment packets are received and the head packets of respective IP fragment packets are not received is continued, it is possible to continue communication without discard of the following packet. In addition, only by using the minimum amount of the buffer in each communication protocol unit, the communication can be continued.

Further, registration of the registered time 2401, the fragment ID 2402, the source IP address 2403, and the destination IP address 2404 in the control information storing unit 307 to be carried out by the packet replication control unit 2302 shown in this embodiment may be carried out by the head packet determining unit 302. In addition, the above-described registered time 2401 of the entry may be a sequence number, for example, if the order of registration can be known.

### Seventh Embodiment

As a seventh embodiment according to the present invention, the embodiment that a following packet corresponding to the following packet to be subject to the compulsory communication is read from the buffer 309 to be transmitted to the communication protocol unit by priority when the vacant capacity of the buffer 309 is left little will be explained below.

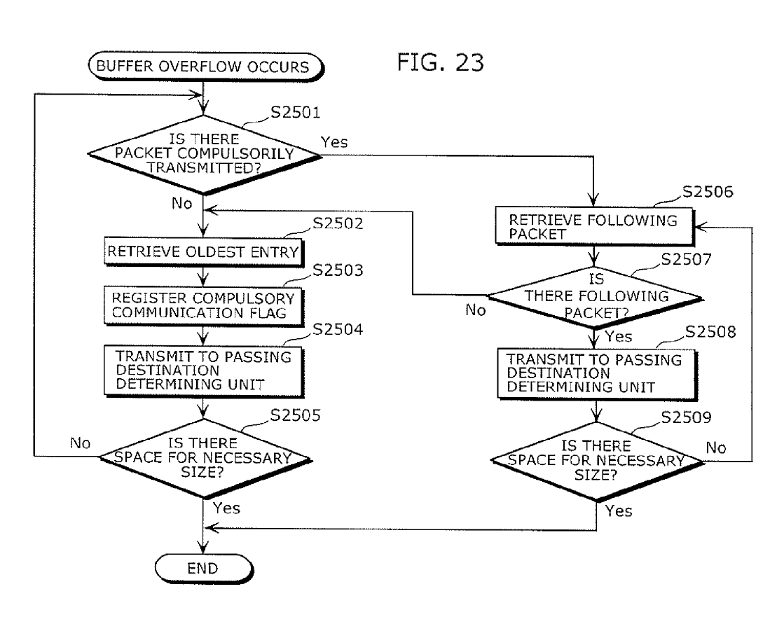

With reference to FIG. 23, the seventh embodiment according to the present invention will be described.

FIG. 23 is a flow chart showing a flow of the operation of the packet replication control unit 2302 according to the seventh embodiment.

The structure of the functional block of the fragment control unit 110 according to the seventh embodiment and the data structure of the control information are the same as the sixth embodiment, and each of these structures is shown in FIG. 21 and FIG. 22, respectively.

The packet replication control unit 2302 according to the seventh embodiment is characterized by referring to a value set in the compulsory communication flag 2405 when taking out the following packet from the buffer 309 and selecting a following packet to be taken out.

Since the operations according to the seventh embodiment are the same as those according to the sixth embodiment other than a selecting method to take out the following packet from the buffer 309, only a difference from the sixth embodiment will be described below.

At first, when the received following packet cannot be stored in the buffer 309 as shown in the sixth embodiment, the following packet is passed from the buffer amount monitoring unit 2301 to the packet replication control unit 2302.

Next, the packet replication control unit 2302 retrieves if there is an entry that a flag value indicating the compulsory communication is set in the compulsory communication flag 2405 among the entries registered in the control information storing unit 307.

If there is the entry that the flag value indicating the compulsory communication is set (Yes at S2501), the packet replication control unit 2302 retrieves the following packet corresponding to this entry, namely, the following packet with which the information of the fragment ID 2402, the source IP address 2403, and the destination IP address 2404 match included in the entry (S2506).

When there is a following packet with which the information of the fragment ID 2402, the source IP address 2403, and the destination IP address 2404 match (Yes at S2507), the packet replication control unit 2302 takes out this following packet from the buffer 309 and outputs it to a passing destination determining unit (S2508). This packet replication control unit 2302 continues this processing until “the packet length of the following packet received from the buffer amount monitoring unit 2301≦the vacant capacity of the buffer 309” is established (No at S2509). When the vacant capacity of the buffer 309 satisfies the above-described conditions (Yes at S2509), the packet replication control unit 2302 stores the received following packet in the buffer 309. Further, the packet replication control unit 2302 registers the registered time 2401, the fragment ID 2402, the source IP address 2403, and the destination IP address 2404 in the control information storing unit 307.

According to the seventh embodiment, when there is no entry having the flag value indicating the compulsory communication set (No at S2501), or when there is an entry having the flag value indicating the compulsory communication set but there is no following packet corresponding to this entry (No at S2507), the packet replication control unit 2302 retrieves an entry having the oldest registered time (hereinafter, referred to as “the oldest entry”) from among the entries registered in the control information storing unit 307 (S2502). Detecting the oldest entry, the packet replication control unit 2302 sets a flag value indicating the compulsory communication in a compulsory communication flag 2405 of the oldest entry (S2503). It is assumed that the subsequent operations follow the sixth embodiment.

In this way, according to the seventh embodiment, it is possible to transmit the following packet corresponding to the entry having the flag value indicating the compulsory communication set by priority to each communication protocol unit. Briefly, as same as the sixth embodiment, without discard of the following packet, the buffer can be efficiently used. Further, each communication protocol unit is only needed to carry out reconstruction of the fragment packet to be transmitted by priority and overhead for reconstruction can be prevented even when receiving and processing the plural fragmented IP fragment packets.

### Eighth Embodiment

As an eighth embodiment according to the present invention, the embodiment for securing more vacant capacity of the buffer 309 when the vacant capacity of the buffer 309 is left little will be described.

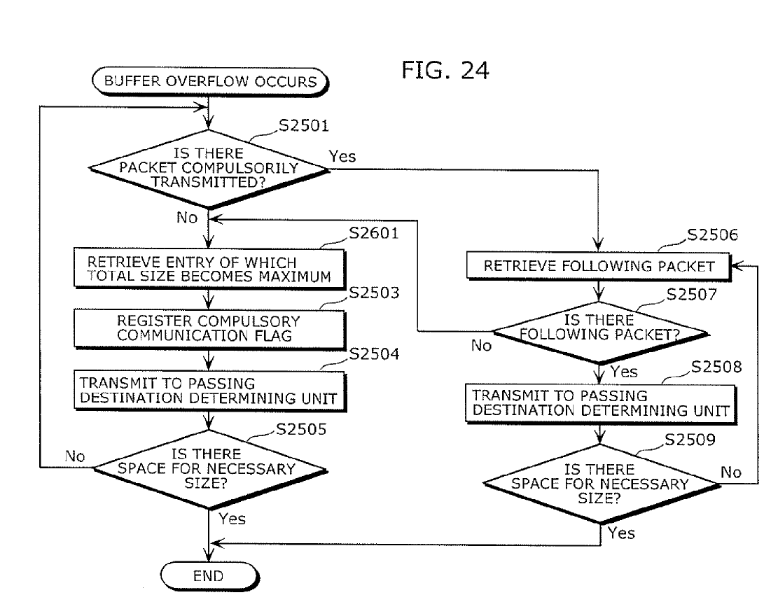

The eighth embodiment according to the present invention will be explained with reference to FIG. 24.

FIG. 24 is a flow chart showing a flow of the operation of the packet replication control unit 2302 according to the eighth embodiment.

Further, the structure of the functional block of the fragment control unit 110 according to the eighth embodiment and the data structure of the control information are the same as the sixth and seventh embodiments, and each of these structures is shown in FIG. 21 and FIG. 22, respectively.

As shown in FIG. 24, the packet replication control unit 2302 according to the eighth embodiment is characterized by selecting a following packet to be taken out in consideration of a size of a following packet when taking out the following packet from the buffer 309.

Since the operations according to the eighth embodiment are the same as those according to the seventh embodiment other than a selecting method to take out the following packet from the buffer 309, only a difference from the seventh embodiment will be described below.

The present embodiment shows an effective using method of the buffer 309 when there is no entry having the flag value indicating the compulsory communication set in the compulsory communication flag 2405 among the entries registered in the control information storing unit. 307 according to the seventh embodiment (No at S2501).

In this case, the entry having the largest total size of the following packet stored in the buffer 309 is selected from among the entries registered in the control information storing unit 307 (S2601).

Briefly, according to the seventh embodiment, the following packet corresponding to the oldest entry is a target of compulsory communication among the following packets stored in the buffer 309, and according to the eighth embodiment, the following packet corresponding to the entry having the largest total size is a target of compulsory communication.

In this way, according to the eighth embodiment, when the vacant capacity of the buffer 309 is left little, it becomes possible that many following packets are taken out all at once from the buffer 309 in the fragment control unit 110 to transmit them to respective communication protocol units. As a result, much vacant capacity can be secured from the buffer 309 and more following packets can be stored. Briefly, it is possible to use the buffer more efficiently than the seventh embodiment.

Further, the fragment control unit 110 may have both of the characteristic of the seventh embodiment and the characteristic of the eighth embodiment. For example, in the case that the vacant capacity of the buffer 309 is left little and there is no following packet subjected to the compulsory communication, at first, the fragment control unit 110 retrieves the entry having the largest total size. As a result of this retrieval, if there is a plurality of entries having the same sizes, selecting the oldest entry, the following packet corresponding to this entry may be a target of the compulsory communication.

Thus, it is possible to more improve efficiency in the use of the buffer 309.

### Ninth Embodiment

As a ninth embodiment according to the present invention, the embodiment for reducing a load according to reconstruction of the packet in each communication protocol unit will be explained.

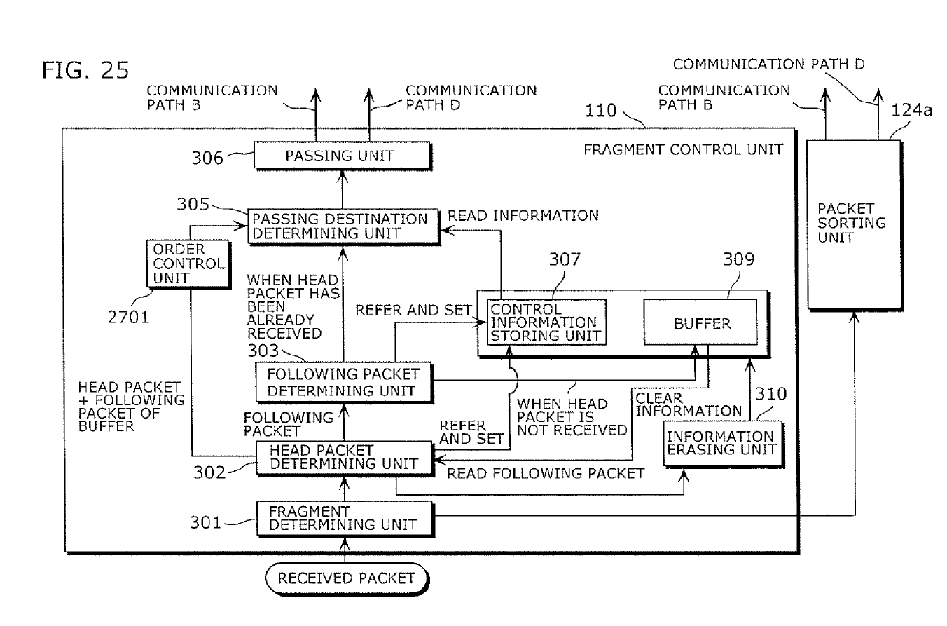

The ninth embodiment according to the present invention will be described with reference to FIG. 25.

FIG. 25 is a functional block diagram showing a functional structure of the fragment control unit 110 according to the ninth embodiment. A packet sorting unit 124a in the drawing is a functional block representing a function in the packet sorting unit 124 other than the function of the fragment control unit 110.

As shown in FIG. 25, the fragment control unit 110 according to the ninth embodiment is configured by adding an order control unit 2701 to the structure of the fragment control unit 110 according to the first embodiment shown in FIG. 10. The order control unit 2701 is an example of the alignment unit in the data communication apparatus according to the present invention.

The operations of the ninth embodiment are the same as those of the first embodiment other than a method to transmit the IP fragment packet from the head packet determining unit 302 to the passing destination determining unit 305. Therefore, a difference from the first embodiment will be mainly explained below.

The head packet determining unit 302 shown in the first embodiment determines whether the inputted received packet is a head packet or not, and if it is a head packet, with reference to the information of the control information storing unit 307, the head packet determining unit 302 checks whether the following packet corresponding to the head packet is stored in the buffer 309. When there is such a following packet, the head packet determining unit 302 carries out the operation to transmit the received head packet and the corresponding following packet to the passing destination determining unit 305.

However, in this case, the head packet and the following packet to be transmitted to the passing destination determining unit 305 are not always transmitted in the order suitable for reconstruction of a fragment and each communication protocol unit should reconstruct a fragment packet received in random order.

Therefore, the order control unit 2701 shown in FIG. 25 aligns the head packet and the following packet received from the head packet determining unit 302 in ascending order at a value of an OFFSET 3407 showing alignment sequence of the IP fragment packets and communicates with the passing destination determining unit 305.

In this way, according to the ninth embodiment, even when the fragment control unit 110 receives the fragment packet in random order, it is possible to transmit the all of the received following packets to each communication protocol unit while correctly aligning the all of the received following packets including the head packet. Thereby, it is possible to reduce a load for reconstruction of a packet in each communication protocol unit.

### Tenth Embodiment

As a tenth embodiment according to the present invention, the embodiment capable of reducing a load for the processing of the ICMP error packet will be explained below.

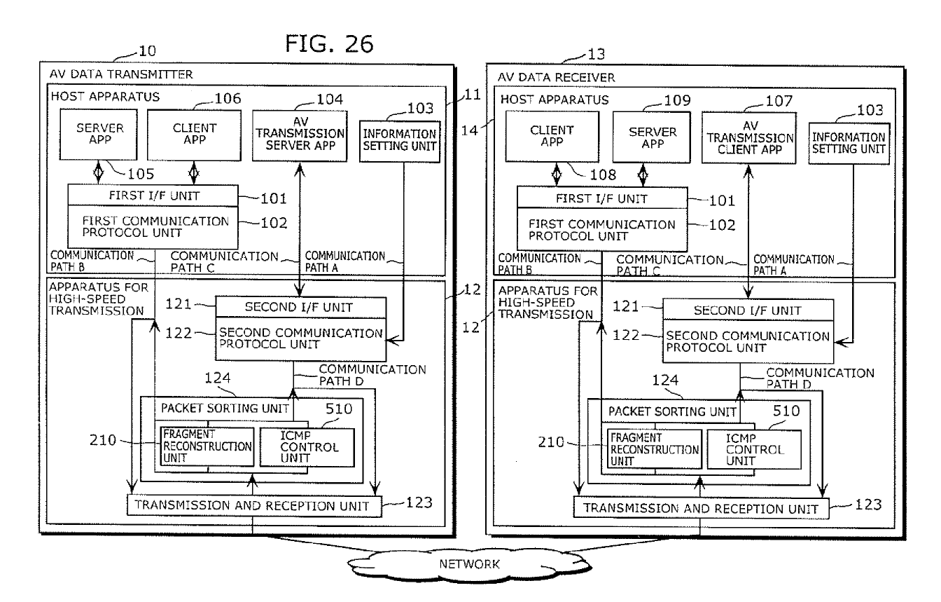

With reference to FIGS. 26 to 28, the tenth embodiment according to the present invention will be described.

FIG. 26 is a functional block diagram showing functional structures of the AV data transmitter 10 and the AV data receiver 13 according to the tenth embodiment.

As shown in FIG. 26, as compared to the conventional AV data transmitter 10 and AV data receiver 13 shown in FIG. 1, the AV data transmitter 10 and AV data receiver 13 according to the tenth embodiment are characterized by having an ICMP control unit 510 in the packet sorting unit 124. The ICMP control unit 510 is a processing unit to efficiently process the received ICMP error message packet.

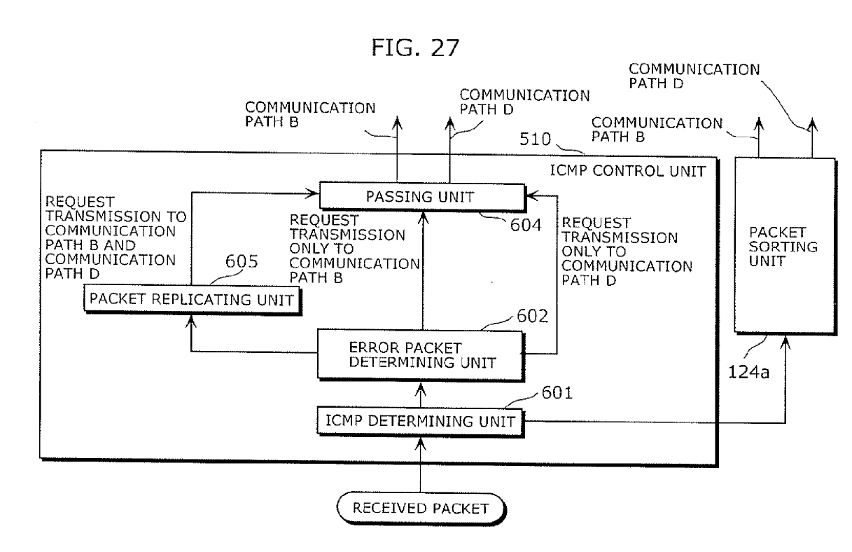

FIG. 27 is a functional block diagram showing a functional structure of the ICMP control unit 510 according to the tenth embodiment. A packet sorting unit 124a in the drawing is a functional block representing a function in the packet sorting unit 124 other than the function of the ICMP control unit 510.

The ICMP control unit 510 receives the ICMP error message packet of the packet format shown in FIG. 16.

In the DATA 3605 of the ICMP error message packet shown in FIG. 16, the IP header in the packet where the error is generated and the head 64 bits of the data following the IP header are stored. Accordingly, when the packet where the error is generated is the TCP packet or the UDP packet, the source port number 3501 and the destination port number 3502 in the TCP header shown in FIG. 12A or the source port number 3513 or the destination port number 3514 in the UDP header shown in FIG. 12A are included in the DATA 3605.

The ICMP control unit 510 can output the ICMP error message packet to an appropriate output destination by using the information stored in the DATA 3605 of this ICMP error message packet.

The information of the error packet is not always stored in the DATA 3605, and it is possible to determine whether the information of the error packet is stored or not depending on the information indicating a kind of error message included in the ICMP error message packet.

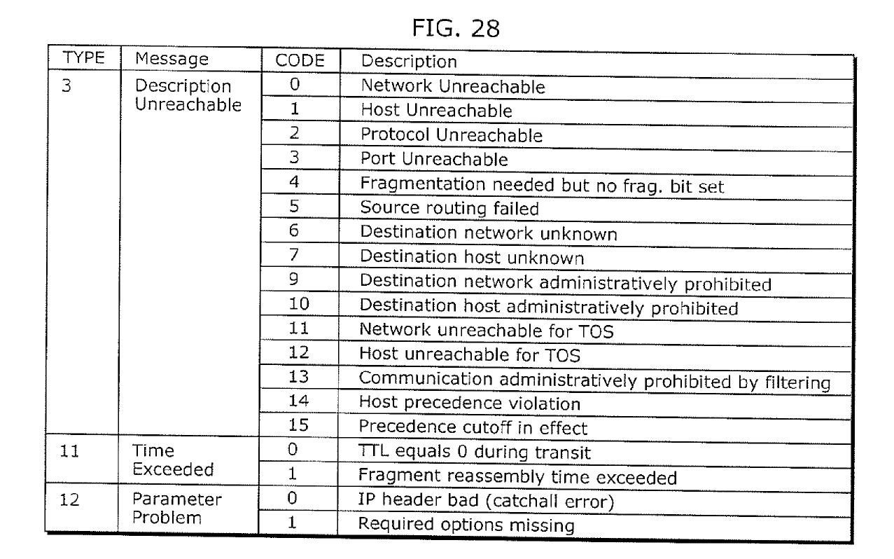

FIG. 28 is a diagram showing kinds of typical ICMP error messages when the information of an error packet is stored in the DATA 3605 of the ICMP error message packet.

“TYPE” and “CODE” shown in FIG. 28 are stored in a type 3601 and a code 3602 of the format shown in FIG. 16, respectively.

Further, the ICMP packet for notifying a message other than the error message is also the same format as the packet format shown in FIG. 16. Whether or not this ICMP packet is the ICMP error message packet can be determined by a value stored in the type 3601 of this ICMP packet.

Each of types “3”, “11”, and “12” shown in FIG. 28 is an example of a type that the ICMP packet is determined to be the ICMP error message packet. This determination is carried out by an ICMP determining unit 601.

Further, due to the value stored in the code 3602, it is possible to determine whether the information of the error packet is stored in the DATA 3605 or not.

Codes from “0” to “15” shown in FIG. 28 are examples of the code, which is determined to have the information of the error packet stored in the DATA 3605. This determination is carried out by an error packet determining unit 602.

The operation of the ICMP control unit 510 will be described.

At first, if the transmission and reception unit 123 receives a packet from the network, the received packet is inputted to the ICMP determining unit 601.

The ICMP determining unit 601 determines whether the so received packet is the ICMP packet or not. As a result of determination, if it is not the ICMP packet, the ICMP determining unit 601 outputs the received packet to the packet sorting unit 124a. The outputted packet is sorted to the appropriate communication path by the processing of the packet sorting unit 124a. In addition, when it is the ICMP packet as a result of determination, the ICMP determining unit 601 outputs it to the error packet determining unit 602.

The error packet determining unit 602 determines whether the ICMP packet is the ICMP error message packet or not from the type 3601 of the inputted ICMP packet. As a result of determination, if it is not the ICMP error message packet, the error packet determining unit 602 outputs it to a packet replicating unit 605. Further, as a result of determination, if it is the error packet, the error packet determining unit 602 determines whether the error packet information is stored in the DATA 3605 or not from the code 3602 of the inputted ICMP packet.

As described above, the type and the code shown in FIG. 28 are examples of the type and the code that the ICMP packet is the ICMP error message packet and the error packet information is stored in the DATA 3605.

In the case that no error packet information is stored in the DATA 3605, the error packet determining unit 602 outputs the received packet to the packet replicating unit 605. In the case that the error packet information is stored in the DATA 3605, the error packet determining unit 602 determines whether the TCP header or the UDP header is stored or not in the DATA 3605. Further, the error packet determining unit 602 checks the source port number of the packet included in the TCP header or the UDP header against the port number used by the second communication protocol unit 122.

As a result of checking, when they match, the error packet determining unit 602 determines that the output destination of this ICMP error message packet is the second communication protocol unit 122, In addition, as a result of checking, if they do not match, the error packet determining unit 602 determines that the output destination of this ICMP error message packet is the first communication protocol unit 102.

Further, the information of the port number used by the second communication protocol unit 122 is held in a predetermined storage area of the packet sorting unit 124.

Then, the error packet determining unit 602 outputs the ICMP error message packet and the information indicating the output destination thereof to a passing unit 604.

The passing unit 604 sorts the inputted ICMP error message packet to the communication path to be the output destination in accordance with the inputted information indicating the output destination.

Further, a packet replicating unit 605 replicates the inputted ICMP packet and outputs two ICMP packets to the passing unit 604 together with an instruction to output this ICMP packet both of the first communication protocol unit 102 and the second communication protocol unit 122.

The passing unit 604 outputs the inputted two ICMP packets to the communication path B and the communication path C in accordance with the inputted instruction.

In this way, the error output unit of the data communication apparatus according to the present invention is realized by the error packet determining unit 602 and the passing unit 604. In addition, by the packet replicating unit 505 and the passing unit 604, the error replicating unit of the data communication apparatus according to the present invention is realized.

According to the tenth embodiment, replication of the packet made by the conventional ICMP replicating unit can be made only for an ICMP error message packet that is required to be replicated.

Thereby, it is possible to decrease a load of the replication processing of the packet. Further, conventionally, the ICMP error message packet will be also outputted to the second communication protocol unit 122 when errors frequently occur in the data communication at the first communication protocol unit 102. In other words, the second communication protocol unit 122 should process the error packet having no relation, and this has an impact to deteriorate the transmission rate of the data communication using the second communication protocol unit 122.

According to the present embodiment, it is possible to minimize the impact on the second communication protocol unit 122 by the ICMP error message packet toward the first communication protocol unit 102.

### Eleventh Embodiment

As an eleventh embodiment, the embodiment relating to exclusive control of the port number of the application program using the first communication protocol unit 102 and the port number of the application program using the second communication protocol unit 122 will be described below.

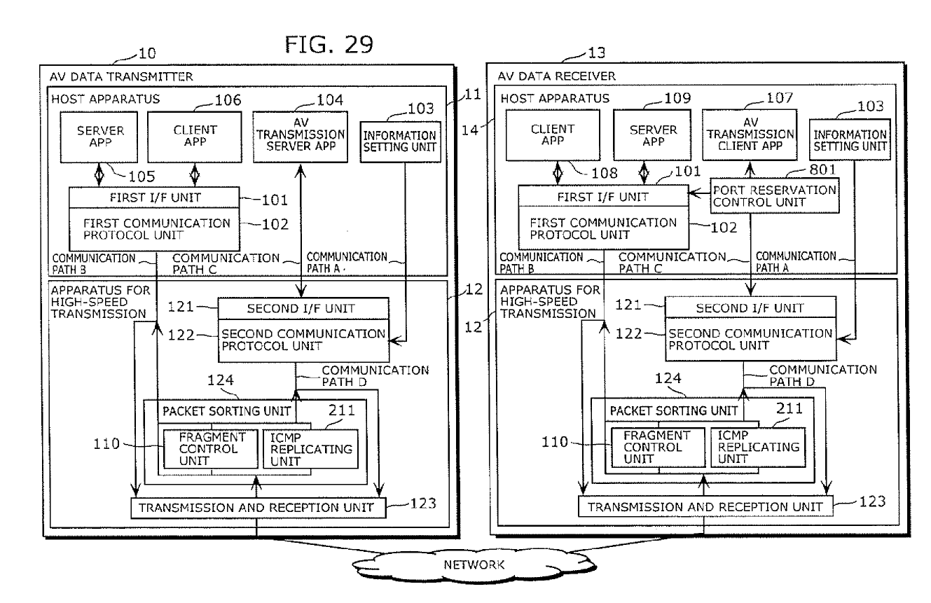

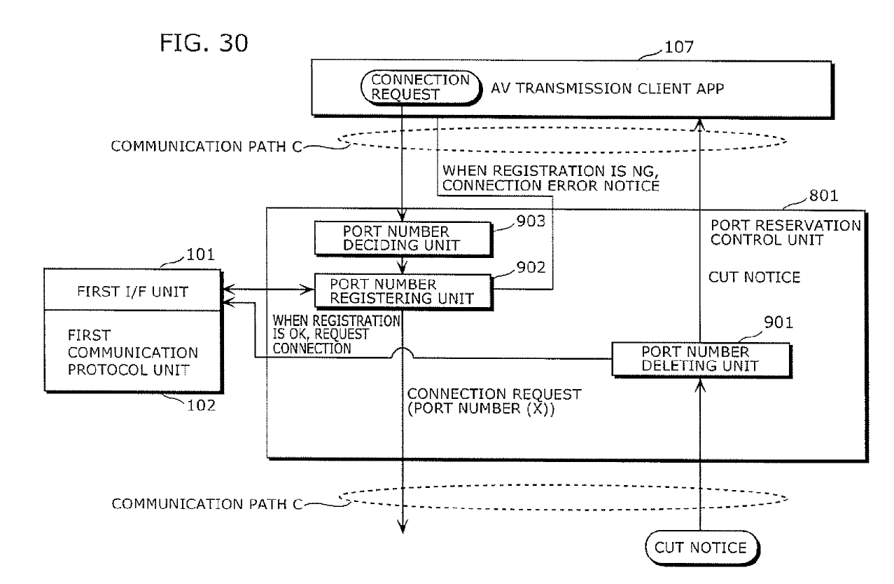

With reference to FIG. 29 and FIG. 30, the eleventh embodiment according to the present invention will be described.

FIG. 29 is a functional block diagram showing functional structures of the AV data transmitter 10 and the AV data receiver 13 according to the eleventh embodiment.

As shown in FIG. 29, the present embodiment is characterized in that the host apparatus 14 of the AV data receiver 13 has the port reservation control unit 801.

A port reservation control unit 801 is a processing unit to register the port number used by an AV transmission client APP 107 in the first communication protocol unit.

FIG. 30 is a functional block diagram showing a functional structure of the port reservation control unit 801 according to the eleventh embodiment. With reference to FIG. 30, the structure and the operation of the port reservation control unit 801 will be described below. A port number deciding unit 903 receives a connection request from the AV transmission client APP 107, which is a client application program for transmitting the AV data. Upon receipt of the connection request, the port number deciding unit 903 decides a port number (X). The port number (X) is decided at s random by using the value obtained by a time management function (GETa_TIM) of the service call offered from the OS. Further, the port number deciding unit 903 is an example of the port number deciding unit in the data communication apparatus according to the present invention.

This port number (X) is decided at random from among unused port numbers in the range of 0 to 65535. The port number deciding unit 903 outputs this decided port number (X) to a port number registering unit 902.

Further, this port number (X) may be decided by a random function. In addition, retrieving the unused port numbers in sequence, these unused port numbers may be used.

Generally, registration of the port number (X) is carried out by using an API offered by a socket. The API to be used is SOCKET, BIND, CONNECT and CLOSESOCKET. The SOCKET generates a socket, the BIND registers a port number and a communication system of the socket, the CONNECT establishes a communication line while requesting connection of a server, and the CLOSESOCKET cuts the communication line and closes the socket

The port number registering unit 902 generates a socket with the first I/F unit 101 using the SOCKET. Next, by using the BIND, the decided port number (X) is registered in the first I/F unit 101.

In the first I/F unit 101, when the port number (X) has been used, the first I/F unit 101 returns, to the port number registering unit 902, the information indicating that registration of the port number fails. The port number registering unit 902 notifies the AV transmission client APP 107 of a connection error.

When the port number (X) is not used in the first I/F unit 101, the first I/F unit 101 returns, to the port number registering unit 902, the information indicating that registration is successful. The port number registering unit 902 uses SOCKET and CONNECT for the second I/F unit 121 and requests connection by using the port number (X).

In addition, upon receipt of a cut notice from the second I/F unit 121, a port number deleting unit 901 deletes the used port number (X) from the first I/F unit 101 by using CLOSESOCKET After that, the port number deleting unit 901 notifies the AV transmission client APP 107 of cutting.

In this way, according to the eleventh embodiment, by registering the port number (X) to be used in the first I/F unit 101, it is possible, without having to modify the first I/F unit 101, to perform exclusive control of the port number used by the AV transmission client APP 107 and the port number of a client APP 108, or the like that uses the first I/F unit 101.

Further, the present embodiment can be also applied when an AV transmission server APP 104 performs communication in a port other than a well-known port (1024 to 65535)

### Twelfth Embodiment

As a twelfth embodiment according to the present invention, the embodiment for reliably reserving a port number for the first communication protocol unit will be described.

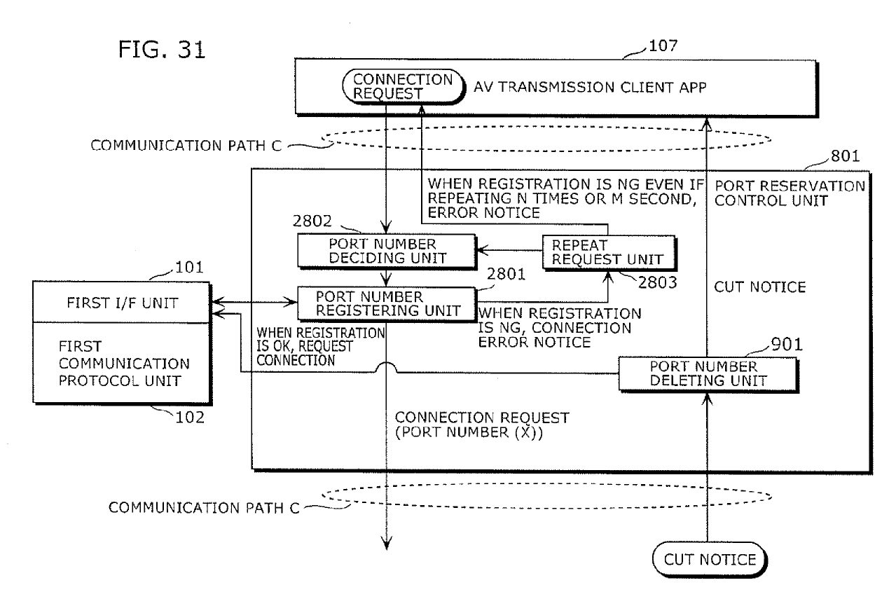

With reference to FIG. 31, the twelfth embodiment according to the present invention will be described below.

FIG. 31 is a functional block diagram showing a functional structure of the port reservation control unit 801 according to the twelfth embodiment.

As shown in FIG. 31, the port reservation control unit 801 according to the twelfth embodiment is characterized by having a repeat request unit 2803 in addition to the structure of the port reservation control unit 801 in the twelfth embodiment shown in FIG. 30. The repeat request unit 2803 is an example of the repeat control unit in the data communication apparatus according to the present invention, and is a processing unit to repeatedly make a request of registration to the port number for the first I/F unit 101.

According to the twelfth embodiment, since the operations thereof are the same as the eleventh embodiment other than the operations of a port number registering unit 2801, a port number deciding unit 2802, and a repeat request unit 2803, only a difference will be described below.

The port number registering unit 2801 notifies the repeat request unit 2803 of connection error when it fails registration of the port number (X) in the first I/F unit 101.

Upon receipt of a connection error notice from the port number registering unit 2801, the repeat request unit 2803 requests registration of a new port number to the port number deciding unit 2802. The repeat request unit 2803 is provided with a restriction function for the number of repetition (N times), and when it continues to fail registration of the port number, the repeat request unit 2803 avoids endless repetition of the request When the number of times to receive the connection error notice is less than the repetition number of times (N times), the repeat request unit 2803 requests registration of a new port number to the port number deciding unit 2802. When the number of times to receive the connection error notice reaches the repetition number of times (N times), the repeat request unit 2803 notifies the AV transmission client APP 107 of the error.

In this way, according to the twelfth embodiment, by providing the repeat request unit 2803 to the port reservation control unit 801, it is possible to repeat registration of the port number in the first I/F unit 101. Accordingly, even if the port number deciding unit 2802 selects the port number, which has been already used in the first I/F unit 101, changing the port number into a different port number, the repeat request unit 2803 repeats re-registration. Therefore, failure of reservation of the port number due to accidental conflict of the port numbers can be avoided, and this enables to make reservation of port number for the first I/F unit 101 substantially reliable.

A repeat restriction of the repeat request unit 2803 shown in the present embodiment may be carried out for a period of time (for example, M seconds). In addition, the AV transmission client APP 107 may request connection and it may designate the number of times or a period of time,

The present embodiment can be also applied when the AV transmission server APP 104 performs communication in a port other than a well-known port (1024 to 65535).

### Thirteenth Embodiment

As a thirteenth embodiment according to the present invention, the embodiment capable of efficiently resolving a physical address of the device with which communication is performed will be described.

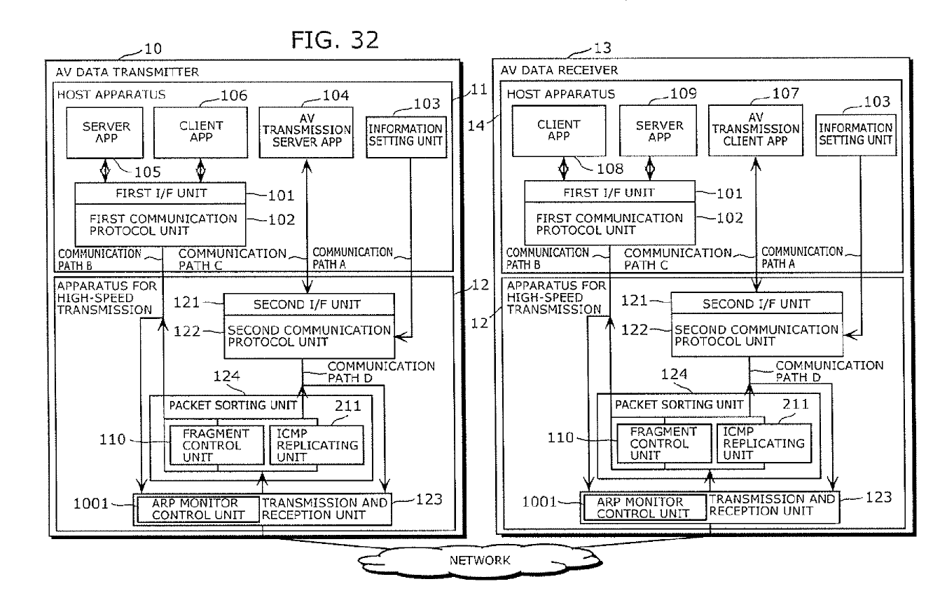

With reference to FIGS. 32 to 35, the thirteenth embodiment according to the present invention will be described below.

FIG. 32 is a functional block diagram showing functional structures of the AV data transmitter 10 and the AV data receiver 13 according to the thirteenth embodiment.

As shown in FIG. 32, the AV data transmitter 10 and the AV data receiver 13 according to the thirteenth embodiment are characterized by having an ARP monitor control unit 1001 in the transmission and reception unit 123 of the apparatus for high-speed transmission 12.

The ARP monitor control unit 1001 is a processing unit to monitor the transmission and reception of an ARP request packet, which is a request for the resolution of the physical address of the device with which communication is performed, and an APP response packet, which is a response to such request, and to output an ARP response packet to an appropriate output destination when receiving it.

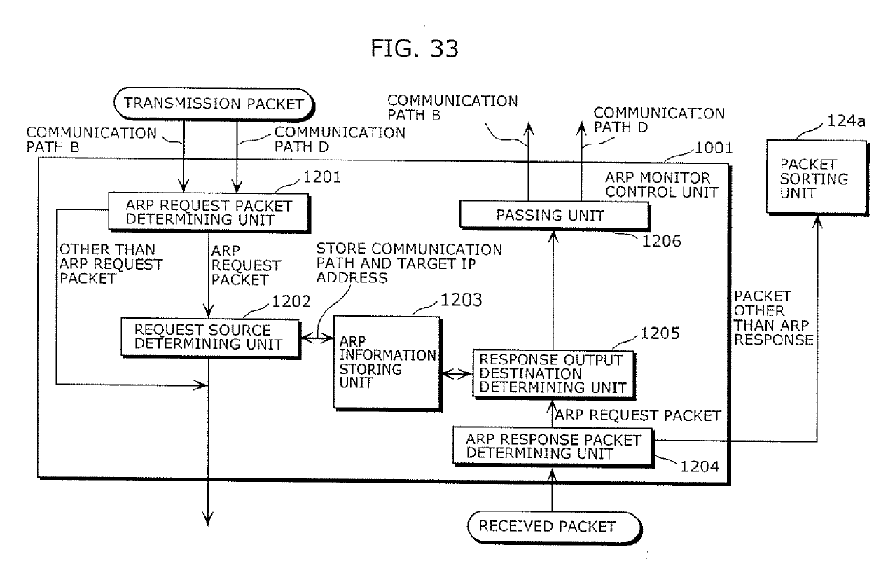

FIG. 33 is a functional block diagram showing a functional structure of the ARP monitor control unit 1001 according to the thirteenth embodiment. A packet sorting unit 124a in the drawing is a functional block representing a function in the packet sorting unit 124 other than the function of the ARP monitor control unit 1001.

Further, an ARP request packet determining unit 1201 is an example of the ARP request receiving unit of the data communication apparatus according to the present invention, an ARP response packet determining unit 1204 is an ARP response receiving unit of the data communication apparatus according to the present invention, and a passing unit 1206 is an example of the response output unit of the data communication apparatus according to the present invention.

Receiving the ARP request packet from the first communication protocol unit 102 or the second communication protocol unit 122, which are directly connected through the communication path B or the communication path D, the ARP monitor control unit 1001 stores the information related to this ARP request packet in an ARP information storing unit 1203.

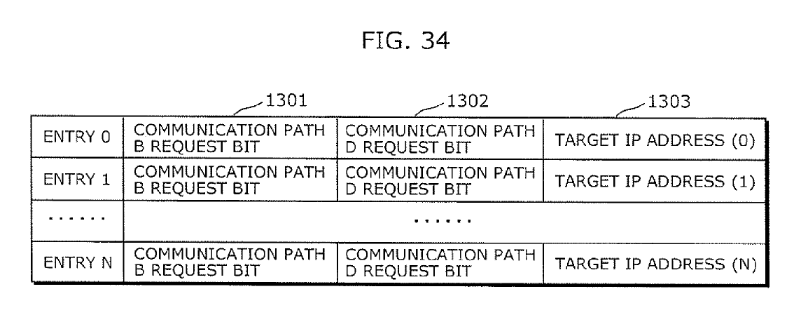

FIG. 34 is a diagram showing a data constructional example stored in the ARP information storing unit 1203 according to the thirteenth embodiment.

As shown in FIG. 34, the ARP information storing unit 1203 stores the information related to the APP request packets received by the ARP monitor control unit 1001 for each of these ARP request packets as an entry.

A communication path B request bit 1301 and a communication path D request bit 1302 of each entry are the information indicating from which communication protocol unit the ARP request packet is transmitted when the ARP monitor control unit 1001 receives this ARP request packet. For example, when the communication path B request bit 1301 rises, namely, when communication path B request bit 1301 is “1”, this indicates that the ARP request packet corresponding to the entry is transmitted from the communication path B. This means that the ARP request packet is transmitted from the first communication protocol unit 102.

In the same way, when the communication path D request bit 1302 is “1”, this means that the ARP request packet is transmitted from the second communication protocol unit 122. Only one of the communication path B request bit 1301 and the communication path D request bit 1302 is set to “1”.

A target IP address 1303 is the information indicating the IP address of the destination of the ARP request packet. “(1)” or the like that follows the target IP address 1303 corresponds to an entry number. The target IP address is the information included in the ARP request packet.

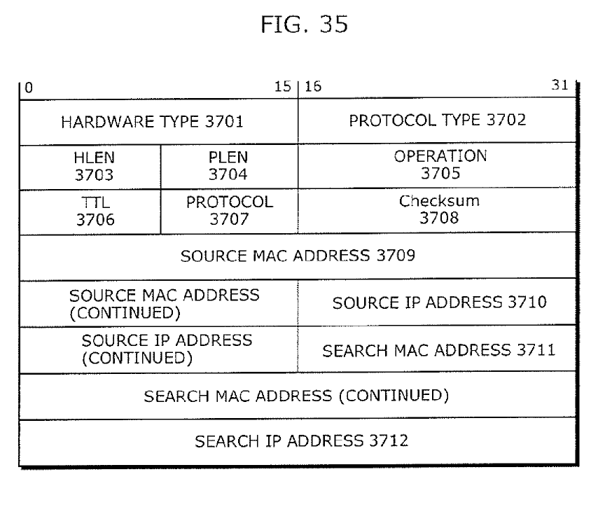

FIG. 35 is a diagram showing a packet format of an ARP packet. The packet formats of the ARP request packet and the ARP response packet are equal to the packet format shown in FIG. 35.

A search IP address 3712 shown in FIG. 35 is the IP address of the destination of the ARP packet. In other words, in the target IP address 1303 of the entry of the ARP information shown in FIG. 34, the search IP address 3712 included in the ARP request packet is stored.

The operation of the ARP monitor control unit 1001 will be described below.

Receiving a transmission packet from the communication path B or the communication path D, the ARP monitor control unit 1001 inputs the transmission packet to the ARP request packet determining unit 1201. The ARP request packet determining unit 1201 determines whether the transmission packet is the ARP request packet or not. Further, a method to determine whether the transmission packet is the ARP request packet or not is a popular specification of an IP protocol, so that the description thereof is herein omitted.

If the transmission packet is not the ARP request packet, the ARP monitor control unit 1001 outputs the transmission packet to the transmission and reception unit 123. If it is the ARP request packet, the ARP monitor control unit 1001 outputs the transmission packet to a request source determining unit 1202.

Reading the search IP address 3712 of the ARP request packet, the request source determining unit 1202 determines the transmission source of the ARP request packet (hereinafter, referred to as “an ARP request source”). After determination, the entry is registered in the ARP information storing unit 1203. The search IP address 3712 is recorded in the target IP address 1303 of the entry and a communication path request bit is set.

Specifically, the request source determining unit 1202 sets the communication path B request bit 1301 to “1” when the ARP request source is the first communication protocol unit 102, and the request source determining unit 1202 sets the communication path D request bit 1302 to “1” when the ARP request source is the second communication protocol unit 122.

After registering the entry in the ARP information storing unit 1203, the request source determining unit 1202 outputs the transmission packet, which is the ARP request packet, to the transmission and reception unit 123.

Then, the ARP monitor control unit 1001 receives the received packet, which is transmitted through a network and is received by the transmission and reception unit 123. The received received packet is inputted to the ARP response packet determining unit 1204. The ARP response packet determining unit 1204 determines whether the received packet is the ARP response packet or not. Further, a method to determine whether the received packet is the ARP response packet or not is a popular specification of an IP protocol, so that the description thereof is herein omitted. If the received packet is not the ARP response packet, the ARP monitor control unit 1001 outputs the received packet to the packet sorting unit 124a. If the received packet is the ARP response packet, the ARP monitor control unit 1001 outputs the received packet to a response output destination determining unit 1205.

Comparing a source IP address 3710 of the ARP response packet with the target IP address 1303 stored in the ARP information storing unit 1203, the response output destination determining unit 1205 searches for an entry that these addresses match. The response output destination determining unit 1205 determines a communication path to output the ARP response packet, depending on whether “1” is set in the communication path B request bit 1301 of the matching entry or the communication path D request bit 1302 of the matching entry.

After determination, the response output destination determining unit 1205 requests the passing unit 1206 to output the ARP response packet to the determined communication path.

The passing unit 1206 outputs the ARP response packet to the output destination requested from the response output destination determining unit 1205. The ARP response packet is received by the first communication protocol unit 102 when it is outputted to the communication path B, and it is received by the second communication protocol unit 122 when it is outputted to the communication path D.

In this way, according to the thirteenth embodiment, the ARP monitor control unit 1001 is provided inside of the packet sorting unit 124. Further, in the ARP information storing unit 1203 of the ARP monitor control unit 1001, the information indicating the target IP address as the destination of the ARP request packet and the information indicating the ARP request source are stored in a state where they are associated with each other. Thereby, it is possible to appropriately sort the ARP response packet, which is a response to the ARP request packet.

As a result, without adding a function to the host apparatus 11 and the host apparatus 14 and without increasing a load of the processing, the physical address can be resolved efficiently. Further, without using the first communication protocol unit 102 by the application program for AV transmission (the AV transmission server APP 104 and the AV transmission client APP 107), the physical address can be resolved.

According to a method to determine the ARP request source by a request source determining unit 2901, the information such as PROTOCOL 3703 of the above-described ARP request packet or the like may be used. In addition, for example, receiving the information indicating from which communication path the ARP request packet is transmitted from the ARP request packet determining unit 1201, this information may be used.

### Fourteenth Embodiment

As a fourteenth embodiment according to the present invention, the embodiment capable of efficiently resolving a physical address of a device with which communication is performed and reducing a load on a network, will be explained below.

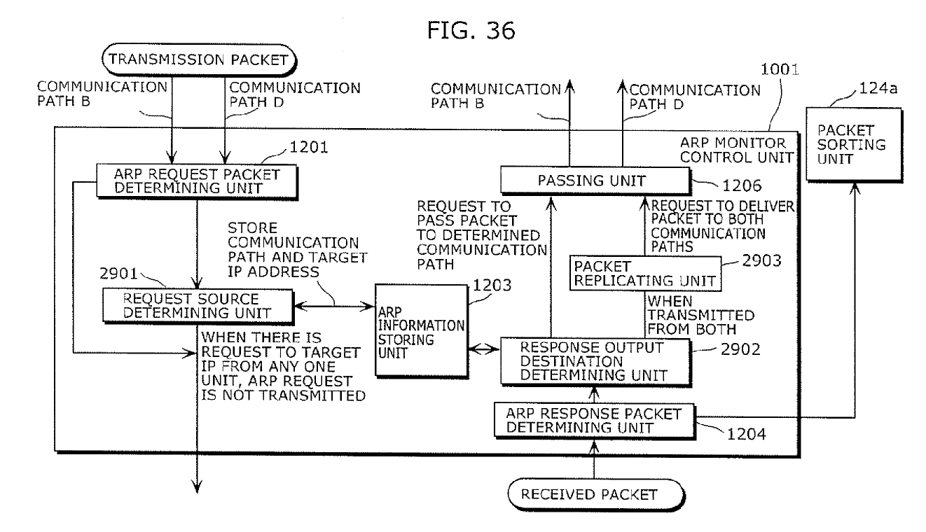

The fourteenth embodiment according to the present invention will be described with reference to FIG. 36.

FIG. 36 is a functional block diagram showing a functional structure of the ARP monitor control unit 1001 according to the fourteenth embodiment.

As shown in FIG. 36, the ARP monitor control unit 1001 according to the fourteenth embodiment is characterized by having a packet replicating unit 2903 in addition to the structure owned by the ARP monitor control unit 1001 according to the thirteenth embodiment. Further, the request source determining unit 2901 is an example of the ARP request source determining unit of the data communication apparatus according to the present invention, and the packet replicating unit 2903 is an example of the ARP packet replicating unit of the data communication apparatus according to the present invention.

Further, the data structure of the ARP information stored in the ARP information storing unit 1203 according to the fourteenth embodiment is the same as the data structure shown in FIG. 34. In addition, the packet format of the ARP packet treated by the ARP monitor control unit 1001 according to the fourteenth embodiment is the same as the packet format shown in FIG. 35.

According to the fourteenth embodiment, the operations are the same as the operation of each constituent element of the thirteenth embodiment other than the operations of the request source determining unit 2901, a response output destination determining unit 2902, and a packet replicating unit 2903 when respective destination of the ARP request packet received from two communication protocol units are the same. Therefore, only a difference from the thirteenth embodiment will be explained.

The request source determining unit 2901 checks whether the search IP address 3712 included in the ARP request packet received from the ARP request packet determining unit 1201 has been already registered in the ARP information storing unit 1203 as the target IP address 1303 or not. If it has been registered, without adding a new entry, the communication request bit corresponding to the ARP request source is set in the entry that this search IP address 3712 is recorded in the target IP address 1303. Briefly, the communication path B request bit 1301 or the communication path D request bit 1302 is set to “1”. In addition, the ARP request packet is not transmitted but is discarded.

For example, the case is assumed that the ARP request packet for the IP address “111. 111. 111. 111” is transmitted from the first communication protocol unit 102 and the ARP request packet for the same IP address “111. 111. 111. 111” is transmitted from the second communication protocol unit 122 before the response to the former request is returned.

In this case, both of the first communication protocol unit 102 and the second communication protocol unit 122 request resolution of the physical address of the same device. Accordingly, only the ARP request packet that was previously transmitted needs to be transmitted to the destination, and a response to such request may be transmitted not only to the first communication protocol unit 102 but also to the second communication protocol unit 122.

Therefore, in order to transmit the ARP response packet corresponding to the ARP request packet that was previously transmitted also to the second communication protocol unit 122, the request source determining unit 2901 also sets, to “1”, the communication path D request bit 1302 of the entry corresponding to the ARP request packet that was previously transmitted.

The operation of each processing unit when the ARP response packet is transmitted to the both communication protocol units is as follows:

Comparing the source IP address 3710 of the ARP response packet received from the ARP response packet determining unit 1204 with the target IP address 1303 stored in the ARP information storing unit 1203, the response output destination determining unit 2902 searches for an entry that these addresses match. The response output destination determining unit 2902 determines the ARP request source depending on whether or not “1” is set in each of the communication path B request bit 1301 of the matching entry and the communication path D request bit 1302 of the matching entry.

When “1” is set in both of the communication path B request bit 1301 and the communication path D request bit 1302, the response output destination determining unit 2902 outputs the ARP response packet to the packet replicating unit 2903.

The packet replicating unit 2903 replicates the ARP response packet, and requests the passing unit 1206 to output the ARP response packet to the communication path B and the communication path D.

The passing unit 1206 outputs the ARP response packet to the both communication paths in accordance with the request. As a result, both of the first communication protocol unit 102 and the second communication protocol unit 122 can receive the ARP response packet.

In this way, according to the fourteenth embodiment, as same as the thirteenth embodiment, the ARP monitor control unit 1001 is provided inside of the packet sorting unit 124. Further, in the ARP information storing unit 1203, the target IP address of the ARP request packet and the ARP request source are stored in a state where they are associated with each other.

However, differently from the thirteenth embodiment, the ARP monitor control unit 1001 transmits only one ARP request packet when receiving the ARP request packet to the same target IP address from the both communication protocol units. Further, in the entry corresponding to this ARP request packet, the information indicating two request sources is registered. After that, if the ARP monitor control unit 1001 receives the ARP response packet as the response to this ARP request packet, the ARP monitor control unit 1001 outputs it to the both communication protocol units.

As a result, the AV data transmitter 10 and the AV data receiver 13 according to the fourteenth embodiment do not carry out the transmission processing of the unnecessary ARP request packet, and further, it is not necessary for the AV data transmitter 10 and the AV data receiver 13 according to the fourteenth embodiment to carry out the reception processing of the ARP response packet, which is a response to this unnecessary ARP request packet. In other words, the AV data transmitter 10 and the AV data receiver 13 according to the fourteenth embodiment have an advantage to reduce a load on a network in addition to efficiency of resolution of the physical address described in the thirteenth embodiment.

### Fifteenth Embodiment

As a fifteenth embodiment according to the present invention, the embodiment capable of resolving a physical address of a device with which communication is performed, and further reducing a load on a network efficiently, will be explained below.

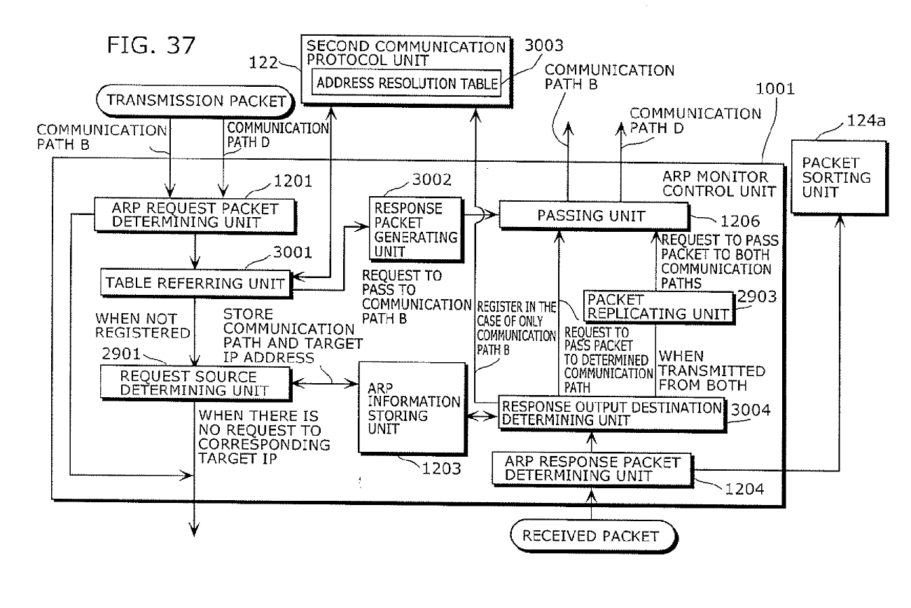

The fifteenth embodiment according to the present invention will be described with reference to FIG. 37.

FIG. 37 is a functional block diagram showing a functional structure of the ARP monitor control unit 1001 according to the fifteenth embodiment.

As shown in FIG, 37, the ARP monitor control unit 1001 according to the fifteenth embodiment is characterized by having a table referring unit 3001 and a response packet generating unit 3002 in addition to the structure owned by the ARP monitor control unit 1001 according to the fourteenth embodiment shown in FIG. 36. Further, the response packet generating unit 3002 is an example of the ARP response generating unit of the data communication apparatus according to the present invention.

An address resolution table 3003 owned by the second communication protocol unit 122 is the table for recording resolved physical address of the device with which communication is performed and the IP address of the other device in a state where the physical address and the IP address are associated with each other.

In addition, in the address resolution table 3003, not only a physical address resolved by the request of the second communication protocol unit 122 but also a physical address resolved by the request of the first communication protocol unit 102 are recorded.

The operations of the ARP monitor control unit 1001 according to the fifteenth embodiment are the same as the operation of each constituent element of the fourteenth embodiment other than the operations of the table referring unit 3001, the response packet generating unit 3002, and a response output destination determining unit 3004. Therefore, only a difference from the fourteenth embodiment will be described.

When the transmission packet is the ARP request packet, the ARP request packet determining unit 1201 outputs the transmission packet to the table referring unit 3001.

With reference to the address resolution table 3003 provided with the second communication protocol unit 122, the table referring unit 3001 checks whether the target IP address of this ARP request packet is recorded or not. When the corresponding target IP address is not recorded, the table referring unit 3001 outputs the ARP request packet to the request source determining unit 2901.

When the corresponding target IP address is recorded, the table referring unit 3001 reads the physical address associated with the target IP address from the address resolution table 3003. Further, discarding the ARP request packet, the table referring unit 3001 notifies the response packet generating unit 3002 of the read physical address and requests generation of the ARP response packet.

Here, the target IP address, which is the destination of this discarded ARP request packet, is recorded in the address resolution table 3003, and from this, it is known that the transmission source of this ARP request packet is not the second communication protocol unit 122. In other words, it is only necessary that the ARP response packet to be generated by the response packet generating unit 3002 may be outputted to the first communication protocol unit 102.

The response packet generating unit 3002 generates the ARP response packet by using the physical address received from the table referring unit 3001.

After the ARP response packet is generated, the response packet generating unit 3002 requests the passing unit 1206 of output of the ARP response packet to the communication path B. The passing unit 1206 outputs the ARP response packet to the communication path B. The outputted ARP response packet is received by the first communication protocol unit 102.

In this way, the ARP request packet to request resolution of the physical address, which has been already resolved, is never transmitted.

In addition, the unresolved physical address, namely, the physical address corresponding to the target IP address not recorded in the address resolution table 3003 will be added to the address resolution table 3003 by the following operation.

The response output destination determining unit 3004 receives the ARP response packet from the ARP response packet determining unit 1204. Further, the response output destination determining unit 3004 determines whether the communication path to which the ARP response packet is outputted is the communication path B or the communication path D from the source IP address 3710 of the ARP response packet and the ARP information stored in the ARP information storing unit 1203.

As a result of determination, when the output destination is the communication path B, the response output destination determining unit 3004 checks that the source IP address 3710 of the ARP response packet is not recorded in the address resolution table 3003 provided to the second communication protocol unit 122. After checking, the source IP address 3710 and the physical address included in the ARP response packet are additionally recorded in the address resolution table 3003.

Further, when the communication path of the output destination of ARP response packet is the communication path D, this ARP response packet is outputted to the second communication protocol unit 122. Therefore, in the second communication protocol unit 122, a new physical address to the address resolution table 3003 is additionally recorded.

In this way, according to the fifteenth embodiment, by providing the table referring unit 3001 to the ARP monitor control unit 1001, it is not necessary to transmit the ARP request packet to the IP address having a physical address that has been already resolved in the first communication protocol unit 102 and the second communication protocol unit 122. Accordingly, it is possible to prevent a redundant packet from being transmitted. As a result, as compared to the fourteenth embodiment, a load on a network can be further reduced.

### Sixteenth Embodiment

In the description of the above-described first to fifteenth embodiments, explanation is only given to characteristic constituent elements in each embodiment. However, the AV data transmitter and the AV data receiver 13 according to each embodiment may be provided with a plurality of characteristic constituent elements in each embodiment at the same time.

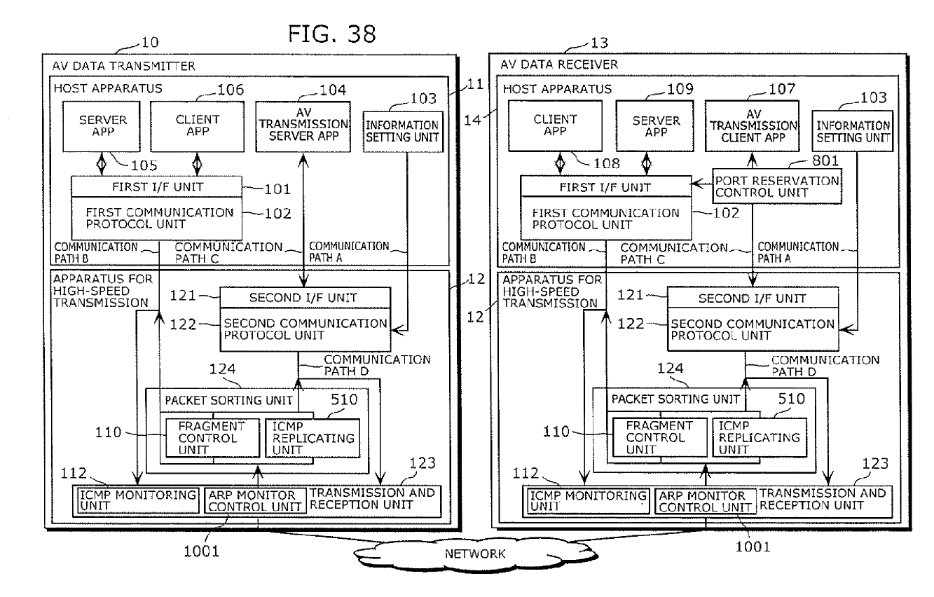

FIG. 38 is a functional block diagram showing functional structures of the AV data transmitter 10 and the AV data receiver 13 having a plurality of constituent elements characterized in the present invention.

In the AV data transmitter 10 and the AV data receiver 13 shown in FIG. 38, the ICMP monitoring unit 112 according to the second embodiment, the ICMP control unit 510 according to the tenth embodiment, and the ARP monitor control unit 1001 according to the thirteenth embodiment are provided to the AV data transmitter 10 and the AV data receiver 13 according to the first embodiment, and further, the port reservation control unit 801 according to the eleventh embodiment is provided to this AV data receiver 13.

For example, the AV data transmitter 10 and the AV data receiver 13 may be provided with each constituent element shown in FIG. 38 at the same time, and the operation and the function of each constituent element do not prevent the operation and the function of other constituent elements.

In addition, in FIG. 38, for example, in place of the ARP monitor control unit 1001 according to the thirteenth embodiment, the ARP monitor control unit 1001 according to the fourteenth embodiment may be provided. In addition, for example, the AV data transmitter 10 may be provided with the port reservation control unit 801. Further, for example, the ICMP monitoring unit 112 may be only provided to the AV data receiver 13.

In other words, the characteristic constituent elements of the present invention such as the ICMP control unit 510 may be freely combined according to the manufacturing cost and need of a user or the like to be provided to the AV data transmitter 10 and the AV data receiver 13.

Thus, it is possible to further reduce generation of an unnecessary configuration and unnecessary processing of the AV data transmitter 10 and the AV data receiver 13.

Although only some exemplary embodiments of this invention have been described in detail above, those skilled in the art will readily appreciate that many modifications are possible in the exemplary embodiments without materially departing from the so novel teachings and advantages of this invention. Accordingly, all such modifications are intended to be included within the scope of this invention.

### INDUSTRIAL APPLICABILITY

The present invention can provide a data communication apparatus, which can reduce generation of an unnecessary configuration and unnecessary processing while installing a communication protocol in each of a host apparatus and an apparatus for high-speed transmission Particularly, the present data communication apparatus is useful for a device to transmit the AV data at a high transmission rate. For example, the present data communication apparatus can be applied to a DVD recorder having a function to transmit AV contents through a network and a digital TV having a function to receive the AV contents through a network and to reproduce them or the like.

What is claimed is:

1. A data communication apparatus comprising a first communication protocol unit operable to perform communication in accordance with a first communication protocol and a second communication protocol unit operable to perform communication in accordance with a second communication protocol, said apparatus performing communication using an Internet Protocol (IP) packet,
wherein the IP packet is made up of a first packet and one or more second packets, the first packet including destination information for specifying whether the IP packet is addressed to said first communication protocol unit or said second communication protocol unit, and the one or more second packets not having the destination information, and
said data communication apparatus comprises:
a receiving unit operable to receive an IP fragment packet, which is the first packet or the second packet;
a destination information storing unit operable to store the destination information;
a buffer for storing the second packet;
a first packet determining unit operable to determine whether or not the IP fragment packet is the first packet, and to store the destination information included in the first packet into said destination information storing unit, in the case where the IP fragment packet is the first packet;
a sorting unit operable to output the first packet to any one of said first communication protocol unit and said second communication protocol unit on the basis of the destination information; and
a second packet control unit operable to perform one of the following in the case where the IP fragment packet is the second packet, which is determined by said first packet determining unit not to be the first packet: passing the second packet to said sorting unit in the case where the destination information is stored in said destination information storing unit; and storing the second packet into said buffer in the case where the destination information is not stored in said destination information storing unit,
wherein, upon receipt of the second packet from said second packet control unit, said sorting unit is operable to output the second packet to any one of said first communication protocol unit and said second communication protocol unit on the basis of the destination information stored in said destination information storing unit.

2. The data communication apparatus according to claim 1,
wherein said first packet determining unit is operable to read the second packet from said buffer and to pass the read second packet to said sorting unit together with the first packet, in the case where said first packet determining unit determines that the IP fragment packet is the first packet and where the second packet is stored in said buffer, and
said sorting unit is operable to output the first packet and the second packet passed from said first packet determining unit to any one of said first communication protocol unit and said second communication protocol unit on the basis of the destination information stored in said destination information storing unit.

3. The data communication apparatus according to claim 2,
wherein each of the first packet and the second packet includes position information indicating a position thereof in the IP packet, and
said data communication apparatus further comprises:
an alignment unit operable to align the first packet and the one or more second packets in accordance with the position information, and
said sorting unit is operable to output the first packet and the one or more second packets aligned by said alignment unit to any one of said first communication protocol unit and said second communication protocol unit on the basis of the destination information stored in said destination information storing unit.

4. The data communication apparatus according to claim 1,
wherein each of said first communication protocol unit and said second communication protocol unit is operable to output a time out notice, in the case where the first packet and all the second packets configuring the IP packet are not inputted within a predetermined period of time, and
said data communication apparatus further comprises:
a time out detecting unit operable to detect the time out notice outputted from said first communication protocol unit or said second communication protocol unit; and
an erasing unit operable to erase the destination information stored in said destination information storing unit in the case where said time out detecting unit has detected the time out notice.

5. The data communication apparatus according to claim 1, further comprising:
a timer that measures passage of time; and
an erasing unit operable to erase the destination information stored in said destination information storing unit and the second packet stored in said buffer, upon receipt of a predetermined notice from said timer,
wherein said first packet determining unit is operable to determine whether or not the IP fragment packet received by said receiving unit is the first packet, and to start said timer, a value indicating a predetermined period of time is set in said timer, and
said timer transmits the predetermined notice to said erasing unit when the predetermined period of time indicated by the value set in said timer has passed after being started by said first packet determining unit.

6. The data communication apparatus according to claim 5,
wherein a first time out value is set in said first communication protocol unit and a second time out value is set in said second communication protocol unit, the first and second time out values, each being a value indicating a period of time waiting for the first packet and all the second packets configuring the IP packet to be present together, and
said data communication apparatus further comprises
a timer setting unit operable to compare the first time out value set in said first protocol unit with the second time out value set in said second protocol unit, and to set one of the first or second time out values in said timer, whichever is greater.

7. The data communication apparatus according to claim 1,
wherein a first time out value is set in said first communication protocol unit and a second time out value is set in said second communication protocol unit, the first and second time out values, each being a value indicating a period of time waiting for the first packet and all the second packets configuring the IP packet to be present together, and
said data communication apparatus further comprises:
a first timer and a second timer, each measuring passage of time;
a timer setting unit operable to set, in said first timer, the first time out value set in said first protocol unit and to set, in said second timer, the second time out value set in said second protocol unit;
a first erasing unit operable to perform one of the following upon receipt of a notice from said first timer indicating that a time indicated by the first time out value has passed: storing, into said destination information storing unit, first passage information indicating that the time indicated by the first time out value has passed, in the case where second passage information is not stored in said destination information storing unit, the second passage information indicating that a time indicated by the second time out value has passed; and erasing the destination information and the second passage information stored in said destination information storing unit, in the case where the second passage information is stored in said destination information storing unit; and
a second erasing unit operable to perform one of the following upon receipt of a notice from said second timer indicating that a time indicated by the second time out value has passed: storing the second passage information into said destination information storing unit, in the case where the first passage information is not stored in said destination information storing unit; and erasing the destination information and the first passage information stored in said destination information storing unit, in the case where the first passage information is stored in said destination information storing unit, and
said sorting unit, upon receipt of the first packet or the second packet, is operable not to output the first packet or the second packet to said first protocol unit regardless of the content of the destination information, in the case where the first passage information is stored in said destination information storing unit, and operable not to output the first packet or the second packet to said second protocol unit regardless of the content of the destination information, in the case where the second passage information is stored in said destination information storing unit.

8. The data communication apparatus according to claim 7, further comprising:
a dummy packet output unit operable to output a dummy packet being one IP fragment packet to said first communication protocol unit; and
a time out measuring unit operable to measure a time from when the dummy packet is outputted from said dummy packet output unit until when said time out measuring unit receives the time out notice outputted from said first communication protocol unit, the time out notice being outputted in accordance with the dummy packet,
wherein said timer setting unit is operable to set, in said timer, the time measured by said time out measuring unit as the first time out value.

9. The data communication apparatus according to claim 1,
wherein the destination information included in the first packet includes a port number and identification information for identifying the IP packet,
the second packet includes the identification information,
said second packet control unit is operable to pass the second packet to said sorting unit, in the case where destination information that includes the same identification information as the identification information included in the second packet is stored in said destination information storing unit, and operable to store the second packet into said buffer in the case where destination information that includes the same identification information as the identification information included in the second packet is not stored in said destination information storing unit, and
said sorting unit is operable, upon receipt of the second packet, to compare a port number included in the destination information that includes the same identification information as the identification information included in the second packet with a port number used by said first communication protocol unit or said second communication protocol unit, so as to determine an output destination.

10. The data communication apparatus according to claim 1, further comprising:
a vacant capacity detecting unit operable to detect a vacant capacity of said buffer; and
a packet replicating unit operable, upon receipt of the second packet from said second packet control unit, to replicate the received second packet, and to pass the resulting two second packets to said sorting unit,
wherein said second packet control unit is further operable to take out a second packet satisfying a predetermined condition from among a plurality of second packets stored in said buffer and to pass the second packet taken out from said buffer to said packet replicating unit, in the case where a size of the second packet to be stored into said buffer exceeds the vacant capacity detected by said vacant capacity detecting unit, and
said sorting unit is operable, upon receipt of the two second packets from said packet replicating unit, to output one of the two packets to said first communication protocol unit, and the other of the two packets to said second communication protocol unit.

11. The data communication apparatus according to claim 10,
wherein the predetermined condition is a condition that the corresponding packet is a second packet stored earliest of all the second packets stored in said buffer, or that the corresponding packet is a second packet with a largest size.

12. The data communication apparatus according to claim 10,
wherein the second packet includes identification information for identifying the IP packet in which the second packet is included,
the identification information of the second packet is written in said destination information storing unit by said second packet control unit, when the second packet is stored into said buffer, and
the second packet control unit is operable to take out a second packet that includes the same identification information as identification information stored earliest into said destination information storing unit, and to pass the second packet taken out from said buffer to said packet replicating unit, in the case where the size of the second packet to be stored into said buffer exceeds the vacant capacity detected by said vacant capacity detecting unit.

13. The data communication apparatus according to claim 10,
wherein the second packet includes identification information for identifying the IP packet in which the second packet is included,
the identification information of the second packet is written in said destination information storing unit by said second packet control unit, when the second packet is stored into said buffer, and
the second packet control unit is operable to
calculate, for each content of identification information stored in said destination information storing unit, a total size of second packets that include identification information with the same content,
take out, from said buffer, one or more second packets with the same identification information, the one or more second packets having a largest total size calculated, and
pass the second packet taken out from said buffer to said packet replicating unit, in the case where the size of the second packet to be stored into said buffer exceeds the vacant capacity detected by said vacant capacity detecting unit.

14. The data communication apparatus according to claim 1,
wherein said receiving unit is further operable to receive an Internet Control Message Protocol (ICMP) error message packet, and
said data communication apparatus further comprises:
an error packet determining unit operable to determine whether or not the ICMP error message packet includes error notice destination information for specifying whether the ICMP error message packet is addressed to said first communication protocol unit or said second communication protocol unit;
an error output unit operable to output the ICMP error message packet to any one of said first communication protocol unit and said second communication protocol unit on the basis of the error notice destination information, the ICMP error message packet having been determined by said error packet determining unit to include the error notice destination information; and
an error replicating unit operable to replicate the ICMP error message packet, which has been determined by said error packet determining unit not to include the error notice destination information, and to output one of the resulting two ICMP error message packets to said first communication protocol unit and the other of the two ICMP error message packets to said second communication protocol unit.

15. The data communication apparatus according to claim 14,
wherein the error notice destination information included in the ICMP error message packet includes a port number, and
said error output unit is operable to compare the port number included in the error notice destination information with a port number used by said first communication protocol unit or said second communication protocol unit, so as to determine an output destination.

16. The data communication apparatus according to claim 1, further comprising:
an interface that receives a registration request and deletion of a port number used by said first communication protocol unit;
a port number deciding unit operable to decide a port number to be used by said second communication protocol unit;
a port number registering unit operable to request, via said interface, said first communication protocol unit to register the port number to be used decided by said port number deciding unit; and
a port number deleting unit operable to delete the port number to be used registered in said first communication protocol unit, in response to a predetermined notice from said second communication protocol unit,
wherein said interface does not accept registration of the same port number as the port number registered in said first protocol unit, and
the port number to be used is not to be used by said first communication protocol unit, in the case where said port number registering unit has been able to register the port number to be used into said first communication protocol unit.

17. The data communication apparatus according to claim 16, comprising:
a repeat control unit operable, in the case where said port number registering unit has not been able to register the port number to be used into said first communication protocol unit, to cause said port number deciding unit to further decide a port number to be used, and operable to cause said port number registering unit to request said first communication protocol unit to register the port number to be used.

18. The data communication apparatus according to claim 17,
wherein said repeat control unit is operable to repeatedly cause said port number deciding unit to decide a port number to be used and to cause said port number registering unit to request said first communication protocol unit to register the port number to be used until said port number registering unit can register the port number to be used into said first communication protocol unit, and until one of the following timings: until a predetermined period of time is passed; and until the number of times that said port number registering unit has not been able to register the port number to be used into said first communication protocol unit reaches a predetermined number of times.

19. The data communication apparatus according to claim 1, further comprising:
an ARP request receiving unit operable to receive an Address Resolution Protocol (ARP) request packet to request for resolution of a physical address of an other device, the ARP request packet being transmitted from said first communication protocol unit or said second communication protocol unit;
an ARP information storing unit operable to store transmission source information, which indicates a transmission source, and a transmission destination address, which is an IP address of the other device in a state where the transmission source information and the transmission destination address are associated with each other, the transmission source information and the transmission destination address being obtained from the ARP request packet received by said ARP request receiving unit;
an ARP transmission unit operable to transmit the ARP request packet to the other device;
an ARP response receiving unit operable to receive an APP response packet transmitted from the other device in response to the ARP request packet;
a response output determining unit operable to determine an output destination of the ARP response packet based on the IP address of the other device and the transmission destination address, the IP address of the other device being obtained from the ARP response packet received by said ARP response receiving unit, and the transmission destination address being stored in said ARP information storing unit; and
a response output unit operable to output the ARP response packet to any one of said first communication protocol unit and said second communication protocol unit in accordance with a result of the determination made by said response output determining unit.

20. The data communication apparatus according to claim 19, further comprising:
an ARP request source determining unit operable, in the case where the same transmission destination address as the transmission destination address obtained from the ARP request packet received by said ARP request receiving unit is stored in said ARP information storing unit, to store the transmission source information obtained from the ARP request packet into said ARP information storing unit in a state where the transmission source information is further associated with the transmission destination address, and to discard the ARP request packet; and
an ARP packet replicating unit operable to replicate the ARP response packet and to pass the resulting two ARP response packets to said response output unit, in the case where the IP address of the other device obtained from the ARP response packet received by said ARP response receiving unit is stored in said ARP information storing unit as a transmission destination address and two different transmission source information are associated with the transmission destination address,
wherein, upon receipt of the two ARP response packets from said ARP packet replicating unit, said response output unit is further operable to output one of the two ARP response packets to said first communication protocol unit, and the other of the two ARP response packets to said second communication protocol unit.

21. The data communication apparatus according to claim 20, further comprising:
an address resolution table that stores the IP address of the other device and the physical address in a state where the IP address and the physical address are associated with each other, the IP address of the other device and the physical address being obtained from the ARP response packet received by said ARP response receiving unit; and
an ARP response generating unit operable to generate an ARP response packet that includes the physical address associated with the IP address of the other device, and to pass the generated APR response packet to said response output unit, in the case where the transmission destination address obtained from the ARP request packet received by said ARP request receiving unit, is stored in said address resolution table as the ARP address of the other device,
wherein, said response output unit, upon receipt of the ARP response packet from said ARP response generating unit, is further operable to output the ARP response packet to any one of said first communication protocol unit and said second communication protocol unit, which is the transmission source of the ARP request packet, and
said response output determining unit is further operable to store the IP address of the other device and the physical address obtained from the ARP response packet in a state where the IP address and the physical address are associated with each other, in the case where the IP address of the other device obtained from the ARP response packet received by said ARP response receiving unit, is not stored in said address resolution table.

22. The data communication apparatus according to claim 1,
wherein said receiving unit is further operable to receive an Internet Control Message Protocol (ICMP) error message packet, and
said data communication apparatus further comprises:
an error packet determining unit operable to determine whether or not the ICMP error message packet includes error notice destination information for specifying whether the ICMP error message packet is addressed to said first communication protocol unit or said second communication protocol unit;
an error output unit operable to output the ICMP error message packet to any one of said first communication protocol unit and said second communication protocol unit on the basis of the error notice destination information, the ICMP error message packet having been determined by said error packet determining unit to include the error notice destination information;
an error replicating unit operable to replicate the ICMP error message packet, which has been determined by said error packet determining unit not to include the error notice destination information, and to output one of the resulting two ICMP error message packets to said first communication protocol unit and the other of the two ICMP error message packets to said second communication protocol unit;
an interface that receives a registration request and deletion of a port number used by said first communication protocol unit;
a port number deciding unit operable to decide a port number to be used by said second communication protocol unit;
a port number registering unit operable to request, via said interface, said first communication protocol unit to register the port number to be used decided by said port number deciding unit;
a port number deleting unit operable to delete the port number to be used registered in said first communication protocol unit, in response to a predetermined notice from said second communication protocol unit;
an ARP request receiving unit operable to receive an Address Resolution Protocol (ARP) request packet to request for resolution of a physical address of an other device, the ARP request packet being transmitted from said first communication protocol unit or said second communication protocol unit;
an ARP information storing unit operable to store transmission source information, which indicates a transmission source, and a transmission destination address, which is an IP address of the other device in a state where the transmission source information and the transmission destination address are associated with each other, the transmission source information and the transmission destination address being obtained from the ARP request packet received by said ARP request receiving unit;
an ARP transmission unit operable to transmit the ARP request packet to the other device;
an ARP response receiving unit operable to receive an ARP response packet transmitted from the other device in response to the ARP request packet;
a response output determining unit operable to determine an output destination of the ARP response packet based on the IP address of the other device and the transmission destination address, the IP address of the other device being obtained from the ARP response packet received by said ARP response receiving unit, and the transmission destination address being stored in said ARP information storing unit; and
a response output unit operable to output the ARP response packet to any one of said first communication protocol unit and said second communication protocol unit in accordance with a result of the determination made by said response output determining unit,
wherein said interface does not accept registration of the same port number as the port number registered in said first protocol unit, and
the port number to be used is not to be used by said first communication protocol unit, in the case where said port number registering unit has been able to register the port number to be used into said first communication protocol unit.

23. A content reproducing apparatus, comprising
said data communication apparatus according to claim 22,
wherein the IP packet is a packet configuring a part or a whole of content data.

24. A content recording and reproducing apparatus, comprising
said data communication apparatus according to claim 22,
wherein the IP packet is a packet configuring a part or a whole of content data.

25. A communication method for performing communication using an IP packet, the method being used in a data communication apparatus that includes a first communication protocol unit operable to perform communication in accordance with a first communication protocol and a second communication protocol unit operable to perform communication in accordance with a second communication protocol,
wherein the IP packet is made up of a first packet and one or more second packets, the first packet including destination information for specifying whether the IP packet is addressed to the first communication protocol unit or the second communication protocol unit, and the one or more second packets not having the destination information,
the data communication apparatus includes:
a destination information storing unit operable to store the destination information; and
a buffer for storing the second packet, and
said communication method comprises:
receiving an IP fragment packet, which is the first packet or the second packet;
determining whether or not the IP fragment packet is the first packet, and causing the destination information storing unit to store the destination information included in the first packet, in the case where the IP fragment packet is the first packet;
outputting the first packet to any one of the first communication protocol unit and the second communication protocol unit on the basis of the destination information; and
performing one of the following in the case where the IP fragment packet is the second packet, which is determined in said determining not to be the first packet:
outputting the second packet to any one of the first communication protocol unit and the second communication protocol unit, in the case where the destination information is stored in the destination information storing unit; and
storing the second packet into the buffer in the case where the destination information is not stored in the destination information storing unit.

26. A program for performing communication using an IP packet, the program being used in a data communication apparatus that includes a first communication protocol unit operable to perform communication in accordance with a first communication protocol and a second communication protocol unit operable to perform communication in accordance with a second communication protocol,
wherein the IP packet is made up of a first packet and one or more second packets, the first packet including destination information for specifying whether the IP packet is addressed to the first communication protocol unit or the second communication protocol unit, and the one or more second packets not having the destination information,
the data communication apparatus includes:
a destination information storing unit operable to store the destination information; and
a buffer for storing the second packet, and
said program causing a computer to execute:
receiving an IP fragment packet, which is the first packet or the second packet;
determining whether or not the IP fragment packet is the first packet, and causing the destination information storing unit to store the destination information included in the first packet, in the case where the IP fragment packet is the first packet;
outputting the first packet to any one of the first communication protocol unit and the second communication protocol unit on the basis of the destination information; and
performing one of the following in the case where the IP fragment packet is the second packet, which is determined in said determining not to be the first packet:
outputting the second packet to any one of the first communication protocol unit and the second communication protocol unit, in the case where the destination information is stored in the destination information storing unit; and
storing the second packet into the buffer in the case where the destination information is not stored in the destination information storing unit.

27. A data communication apparatus that performs communication using an Internet Protocol (IP) packet, said apparatus comprising:
a first communication protocol unit operable to perform communication in accordance with a first communication protocol;
a second communication protocol unit operable to perform communication in accordance with a second communication protocol;
a receiving unit operable to receive an Internet Control Message Protocol (ICMP) error message packet;
an error packet determining unit operable to determine whether or not the ICMP error message packet includes error notice destination information for specifying whether the ICMP error message packet is addressed to said first communication protocol unit or said second communication protocol unit;
an error output unit operable to output the ICMP error message packet to any one of said first communication protocol unit and said second communication protocol unit on the basis of the error notice destination information, the ICMP error message packet having been determined by said error packet determining unit to include the error notice destination information; and
an error replicating unit operable to replicate the ICMP error message packet, which has been determined by said error packet determining unit not to include the error notice destination information, and to output one of the resulting two ICMP error message packets to said first communication protocol unit and the other of the two ICMP error message packets to said second communication protocol unit.

28. A data communication apparatus that performs communication using an Internet Protocol (IP) packet, said apparatus comprising:
a first communication protocol unit operable to perform communication in accordance with a first communication protocol;
a second communication protocol unit operable to perform communication in accordance with a second communication protocol;
an interface that receives a registration request and deletion of a port number used by said first communication protocol unit;
a port number deciding unit operable to decide a port number to be used by said second communication protocol unit;
a port number registering unit operable to request, via said interface, said first communication protocol unit to register the port number to be used decided by said port number deciding unit; and
a port number deleting unit operable to delete the port number to he used registered in said first communication protocol unit, in response to a predetermined notice from said second communication protocol unit,
wherein said interface does not accept registration of the same port number as the port number registered in said first protocol unit, and
the port number to be used is not to be used by said first communication protocol unit, in the case where said port number registering unit has been able to register the port number to be used into said first communication protocol unit.

29. A data communication apparatus that performs communication using an Internet Protocol (IP) packet, said apparatus comprising:
a first communication protocol unit operable to perform communication in accordance with a first communication protocol;
a second communication protocol unit operable to perform communication in accordance with a second communication protocol;
an ARP request receiving unit operable to receive an Address Resolution Protocol (ARP) request packet to request for resolution of a physical address of an other device, the ARP request packet being transmitted from said first communication protocol unit or said second communication protocol unit;
an ARP information storing unit operable to store transmission source information, which indicates a transmission source, and a transmission destination address, which is an 1P address of the other device in a state where the transmission source information and the transmission destination address are associated with each other, the transmission source information and the transmission destination address being, obtained from the ARP request packet received by said ARP request receiving unit;
an ARP transmission unit operable to transmit the ARP request packet to the other device;
an ARP response receiving unit operable to receive an ARP response packet transmitted from the other device in response to the ARP request packet;
a response output determining unit operable to determine an output destination of the ARP response packet based on the IP address of the other device and the transmission destination address, the IP address of the other device being obtained from the ARP response packet received by said ARP response receiving unit, and the transmission destination address being stored in said ARP information storing unit; and
a response output unit operable to output the ARP response packet to any one of said first communication protocol unit and said second communication protocol unit in accordance with a result of the determination made by said response output determining unit.
